(19) United States
(12) Patent Application Publication
(10) Pub. No.: US 2002/0126291 A1
(43) Pub. Date: Sep. 12, 2002

(54) Spectrum division multiplexing for high channel count optical networks

(76) Inventors: Charles X. W. Qian, Cupertino, CA (US); Yifan Li, Fremont, CA (US); Yi Qin, Pleasanton, CA (US); Zhenpeng Su, Fremont, CA (US)

Correspondence Address: MORRISON & FOERSTER LLP, 425 MARKET STREET, SAN FRANCISCO, CA, 94105-2482, US

(21) Appl. No.: 10/032,180

(22) Filed: Dec. 21, 2001

Related U.S. Application Data
(63) Continuation-in-part of application No. 09/738,904, filed on Dec. 16, 2000.

(51) Int. Cl. G01B 9/02

(52) U.S. Cl. 356/450

(57) ABSTRACT

An optical interleaver comprising: an interferometer which includes a coupler, a first phase shifter and a combiner; wherein the coupler splits incident light into a first light beam and a second light beam and couples the first light beam and the second light beam to the first phase shifter; wherein the first phase shifter includes a first light propagation element that propagates the first light beam along a first path between the coupler and the combiner and that includes a second light propagation element that propagates the second light beam along a second path between the coupler and the combiner, the first and second paths having different path lengths that contribute to a phase shift between light of the first light beam propagated along the first path and light of the second light beam propagated along the second path; wherein the combiner couples the first light beam with and the second light beam; a second phase shifter which receives first light beam light propagated along the first path between the coupler and the combiner and imparts a first wavelength dependent variation in phase to the received first light beam light; a third phase shifter which receives second light beam light propagated along the second path between the coupler and the combiner and imparts a second wavelength dependent variation in phase to the received second light beam light.

### CROSS REFERENCE TO RELATED APPLICATIONS

This application is a continuation-in-part of commonly assigned pending application Ser. No. 09/738,904 filed Dec. 16, 2000.

### BACKGROUND OF THE INVENTION

1. Field of the Invention

The present invention relates generally to the field of optical communications and more particularly to wavelength/spectrum interleaving in dense wavelength division multiplexing (DWDM) applications.

2. Description of the Related Art

Optical communications is an active area of new technology and is crucial to the development and progress of several important technologies, e.g., Internet and related new technologies. A key technology that enables higher data transmission rate is dense wavelength division multiplexing (DWDM). In the DWDM technology, optical signals (Information modulated light at prescribed wavelengths) generated from different sources operating at predetermined, densely spaced center wavelengths, are combined (or multiplexed) to form a single multiplexed optical signal comprising multiple different individually modulated light signals at multiple corresponding different wavelengths. This multiplexed optical signal is transmitted through an optical fiber. The optical signal typically must be amplified one or more times in order to traverse longer distances.

DWDM technology also is used to de-multiplex a multiplexed signal so as to separate individual signal wavelengths, sometimes referred to as channels. Each such channel is characterized by a prescribed center frequency, and there is a prescribed spacing between any two adjacent channels which is a constant (e.g., 200 GHz or 100 GHz, per ITU standard). Ordinarily, all channels are given frequency windows with identical widths. The width of these windows generally is kept great enough to pass information associated with these data channels and at the same time as narrow as possible to limit cross-talk between different data channels. It is generally understood that the narrower the frequency spacing between different data channels, the greater the transmission capacity a DWDM system will have at a given bit rate.

There exist several different types of wavelength separating and combining devices that can be characterized generally as DWDMs. These devices fall roughly into three categories: wavelength filters, wavelength dispersion devices and wavelength interleavers. A wavelength filter transmits (or reflects) one or more prescribed wavelengths. A wavelength dispersion device separates a light beam into multiple constituent wavelengths. Conversely, it combines light of a plurality of wavelengths into a composite beam. A wavelength interleaver can both combine multiple wavelengths of light and separate multiple wavelengths of light A wavelength interleaver can be used to separate a beam into at least two sub-beams, in which each sub-beam comprises a prescribed plurality of wavelengths, and in which the wavelengths in at least two sub-beams are interleaved relative to one another in that one or more wavelengths in one sub-beam fall within the spacing between wavelengths in the other sub-beams(s). Conversely, a wavelength interleaver typically can be used to combine separate beams comprising interleaved wavelengths into a composite beam. Each multi-wavelength (sub) beam may be referred to as a channel. Optical Networks by R. Ramaswami and K. N. Sivarajan, Morgan Kaufman Publishers, San Francisco, 1998, provides an excellent overview of optical networking and communications technologies in general and DWDM in particular.

The illustrative drawings of FIGS. 1A-1C show examples of typical wavelength filters. FIG. 1A is a generalized block diagram by a optical filter (100) which serves the function of separating signals within a predetermined frequency window 104 from an input spectrum 102. The remaining signals are channeled into OUT2 (106). In a typical earlier DWDM system, to de-multiplex composite data, an optical filter is employed to separate signals associated with a particular data channel as depicted in FIG. 1A. Generally, each wavelength channel requires a specific filter, therefore, a DWDM de-multiplexer usually will require n optical filters in cascade in order to separate all of a number n wavelength channels into separate wavelength outputs. Using these filter cascades in the reverse direction will enable the construction of a multiplexer with which individual wavelength channels with different center wavelengths, can be combined together to form a composite optical output signal.

The illustrative drawing of FIG. 1B shows one example of a type of wavelength filter commonly known as a fiber Bragg grating (FBG) 110. In a FBG, the index of refraction of the optical fiber is modified with a periodic pattern. The period of the modification, d, is related to the center wavelength λₘ of the given filter as λₘ=2 nᵣ d/m. Where m is the order of the Bragg grating and nᵣ is average of the index of refraction of the fiber.

The illustrative drawing of FIG. 1C shows another example of a type of wavelength filter referred to as a multi-layer interference filter 120. These filters typically are constructed with several, sometimes many, layers of different optical materials with varying thickness such that a desired transmission (or reflection) curve centered near a predetermined channel center-frequency is obtained. A thin film filter ordinarily operates as a Fabry-Perot interferometer or etalon where the mirrors surrounding the cavity are realized using multiple dielectric think film layers. This device typically operates as a band pass filter, passing a prescribed wavelength and reflecting all others. The wavelength that is passed is determined by the cavity length.

One problem with wavelength filters is that several of them ordinarily must be cascaded together in order to separate a composite optical signal (one including multiple information modulated wavelengths) into its constituent wavelengths. A DWDM system employing wavelength filters, therefore, typically comprises many such filters optically connected so that a composite light signal is separated into its constituent wavelengths as it propagates in one direction through the cascaded filters, and so that the different light beams of the different wavelengths are combined into the composite beam as they propagate in the opposite direction through the DWDM.

The illustrative drawings of FIGS. 2A-2C show examples of several known wavelength dispersion devices. Referring to the illustrative drawings of FIG. 2A, there is shown a device commonly known as an arrayed waveguide grating (AWG) 200. As depicted, these AWG can be used to separate multiple optical data channels simultaneously. In the example of FIG. 2A, each channel includes only a single information carrying wavelength. The output channels 204-i can be connected directly to individual optical fibers. When using an AWG in the reverse direction, many different optical signal channels can be combined into a single optical fiber. FIG. 2B shows an illustrative drawing of a prism 210 which can also be used to multiplex or de-multiplex optical signals. The exit angle of different wavelengths is different because the index of refraction is different for different wavelengths (which is the same as saying for different frequencies) that the exit angle is different for channels having different center frequencies. Different output channels 214-i are separated in space and can be connected into individual fibers. FIG. 2C illustrates another commonly used device known as a diffraction grating 220. An optical surface is modified with a periodical pattern (with a period d) such that when light is directed to the modified surface, the angle of incidence (α) and diffraction (β) are related to the wavelength of the incoming light, λ according to: d (sin α+sin β)=mλ, where m is an integer commonly referred as the order of diffraction.

The illustrative drawings of FIGS. 3A-6B show various examples of prior interleavers. The illustrative drawing of FIG. 3A shows a generalized block diagram of a third type of wavelength separating and combining devices are known as an interleaver. In the example illustrated in FIG. 3A, the interleaver 300 separates a composite optical signal 302 into two complementary signals in which individual wavelength channels are interleaved relative to one another as shown in FIG. 3B. The optical signal of OUT 1 304 includes the individual wavelength channels labeled as odd channel. The optical signal of OUT 2 306 includes the individual wavelengths labeled as even channels. In the interleaver example shown, the frequency (and conversely, wavelength) space is divided into two parts, 50% for OUT 1 and 50% for OUT 2, as illustrated in the illustrative drawing of FIG. 3B.

The illustrative drawings of FIGS. 3C and 3D show examples of two typical interleaver devices. FIG. 3C illustrates an interleaver 320 employing a Gires-Toumois (GT) mirror and a Michelson interferometer. An interleaver of this general type was first described by Dingel and Izutsu in a publication (Optics Letters, Jul. 15, 1998, vol 23, pages 1099-1101) which is incorporated herein by this reference as relevant background material. In this interleaver 320 an input signal 322 is coupled to a 50% beam splitter 321 through a collimating lens 329. A GT mirror 327 and a regular mirror 325 are used to form the interferometer. Odd wavelength channels return to one output fiber 324 through a lens 329 whereas the even wavelength channels return to the other fiber 326 through another lens 329. This general type of interleaver and related devices have been disclosed in U.S. Pat. No. 6,169,626 issued to Chen et al.

The illustrative drawing of FIG. 3D shows another example of an interleaver 330 that employs a 50% beam splitter and a GT mirror. An interleaver of this general type is disclosed in U.S. Pat. No. 6,169,604 issued to Cao. An input signal 332 is coupled to a 50% beam splitter 331 through a collimating lens 339. Two sections of a phase modified GT mirror 335 are used as two mirrors of the interferometer. The odd wavelength channels return to one output fiber (334) through lens (339) whereas the even wavelength channels return to the other fiber (336) through another lens (339).

The illustrative drawing of FIG. 3E shows another example of an interleaver disclosed in U.S. Pat. No. 6,222,958. A Mach-Zhender interferometer is coupled to two GT resonators. Each arm of the MZI is coupled to one of the GTs. The lengths of the two GT cavities differ slightly from one another. Each of the GTs imparts an interference pattern to the light imparted to it that depends upon its cavity length. In operation, the interleaver separates composite light on the input into two sub-beams with interleaved wavelengths.

FIG. 4A is an illustrative drawing showing two stages of interleavers 400, 410, 420 cascaded to provide four outputs 414, 416, 424, 426 each carrying one fourth of the original data channels. It will be appreciated that different data channels correspond to different wavelengths. In this example, the frequency spacing of the adjacent data channels for a particular output is therefore four times the spacing between adjacent data channels in the input signal 402. FIG. 4B shows another prior cascaded interleaver configuration which utilizes both the interleaver 430 and wavelength dispersion devices 440, 450. In this configuration, the optical alignment and/or temperature stability requirements for the dispersion devices are significantly less stringent when the channel spacing is increased to twice that of the original spacing. An example of yet another cascaded interleaver configuration is shown in FIG. 5 in which an interleaver 500 is followed by individual filters. In this example configuration, filters with a larger channel spacing and hence lower tolerance (e.g., 200 GHz filters) can be used to construct DWDM systems with a smaller channel-spacing (e.g., 100 GHz or 50 GHz).

In many optical network applications, there is a need to separate a group of signal channels and redirect these channels. Ordinarily, this is accomplished using devices called add-drop modules. The illustrative drawing of FIG. 6 represents a DWDM long haul system 600 with multiple add-drop modules. The optical signals of different center wavelengths 602 are combined through a DWDM multiplexer 603 and amplified using amplifiers 605. At a branching point 606, a group of information carrying wavelength channels is dropped through add-drop modules, and replaced with information carrying wavelength channels from alternate sources. This modified composite signal is transferred to a demultiplexer 607, separated into individual wavelength channels and sent to their corresponding receivers 608.

FIG. 6B is an illustrative drawing of one example type of add/drop module. The example add/drop module 610 employs interference filters. An incoming optical signal 612 is directed to a first interference filter 614 where optical signal channels associated with the channel to be dropped pass through as a drop output 613. The remaining signal channels reflect from the first filter 614 to a second filter 615, and are combined with the add input wavelengths 616 to form the output wavelengths 618.

One of the disadvantages of interleavers employing earlier add/drop modules is that adding and/or dropping a group of signal channels often involves many filtering components and modules. Therefore, there exists a need for improvements in accomplishing a multi-channel add-drop function. There also exists a need for an improved interleaver.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIGS. 1A-1C (prior art) are simplified diagrams illustrating conventional filters and their use in DWDM technology. FIG. 1A is a block diagram illustrating the operation of a generic filter device. FIG. 1B depicts a fiber Bragg grating filter. FIG. 1C represents a multi-layer interference filter;

FIGS. 2A-2C (prior art) are simplified diagrams illustrating conventional dispersion multi-channel devices and their use in DWDM technology. FIG. 2A is a diagram illustrating the operation of an arrayed waveguide grating (AWG) device. FIG. 2B represents a prism wavelength dispersion device. FIG. 2C shows the operation of a conventional grating device;

FIGS. 3A-3E (prior art) are simplified diagrams illustrating conventional interleaver devices and their use in DWDM technology. FIG. 3A is a block diagram illustrating the operation of an interleaver. FIG. 3B displays the output frequency spectra associated with two output signals. FIG. 3C shows an interleaver based on a GT mirror and a regular mirror; FIG. 3D depicts the operation of an interleaver based upon a GT mirror and a Michelson interferometer; and FIG. 3E depicts operation of an interferometer comprising a Mack Zhender interferometer and two GT resonators;

FIGS. 4A-4B (prior art) are schematic diagrams illustrating DWDM applications utilizing interleavers. FIG. 4A is a block diagram of three interleavers in a cascade. The four outputs each carries ¼ of the signal channels from the original composed input signal. FIG. 4B is a schematic diagram illustrating the combination of an interleaver and two multi-channel dispersion devices (prisms);

FIG. 5 (prior art) depicts a device composed of interleaver and filters. Each output of the device caries only one signal channel;

FIGS. 6A-6B (prior art) are diagrams illustrating a multichannel add/drop function in an optical network. FIG. 6A depicts a multichannel add/drop arrangement in a long haul system. FIG. 6B shows a filter based add-drop module;

FIG. 7A shows a generalized block diagram of an interleaver that may be constructed in accordance with an embodiment of the invention; and FIG. 7B shows illustrative wavelength spectra output by the illustrative interleaver of FIG. 7A;

FIGS. 8A-8C show illustrative generalized schematic diagrams of three alternative embodiments of an interleaver in accordance with certain aspects of the invention;

FIGS. 9A-9B show illustrative drawings of an embodiment of an interleaver which includes multiple GT resonators that serve as phase shifters in accordance with certain aspects of the invention; FIG. 9C shows illustrative first and second light output wavelength spectra of the embodiment of FIGS. A-B and first and second GT mirror back surface leakage spectra of the embodiment of FIGS. 9A-B;

FIG. 10 shows an illustrative drawing of an embodiment of an interleaver which includes multiple ring resonators that serve as phase shifters in accordance with certain aspects of the invention;

FIG. 11 shows an illustrative drawing of an embodiment of an interleaver which includes waveguide MZI and multiple GT resonators that serve as phase shifters in accordance with certain aspects of the invention;

FIG. 12 shows an illustrative drawing of an embodiment of an interleaver which includes fiber MZI and multiple GT resonators that serve as phase shifters in accordance with certain aspects of the invention;

FIG. 13 shows an illustrative drawing of an embodiment of an interleaver which includes an MZI and multiple groups of waveguide segments that serve as phase shifters in accordance with certain aspects of the invention;

FIG. 14 shows a generalized block diagram of a spectrum exchanger that may be implemented in accordance with the present invention;

FIG. 15 shows a generalized block diagram of an add/drop multiplexer which may be implemented in accordance with the present invention;

FIG. 16A shows a generalized block diagram of a one to four Spectrum De-Multiplexer (SDEMUX) constructed with multiple cascaded OSS devices; and FIG. 16B shows a proposed symbol for an SDEMUX;

FIGS. 17A-17B shows a generalized block diagram of demultiplexer devices and multiplexer devices that can be constructed using OSS devices in accordance with the invention;

FIG. 18 shows a generalized block diagram of a long haul system comprising an SDEMUX, an SMUX, multiple optical fibers and 1806-4 and multiple optical amplifiers and in accordance with the invention;

FIG. 19A shows a generalized block diagram of an optical spectrum add/drop module (OSAD) that may be implemented in accordance with the invention; and FIG. 19B shows a proposed symbol for an OSAD;

FIG. 20 shows an illustrative drawing of one use of an OSAD in accordance with the invention;

FIG. 21A is a generalized block diagram of a 1×4 Spectrum Switch (SS) in accordance with a present embodiment of the invention; and FIG. 21B shows a proposed symbol for such a switch;

FIG. 22, shows a generalized block diagram of a 4×4×4 Spectrum Cross-Connect (SCC) in accordance with a present embodiment of the invention;

FIGS. 23 A-23B show diagrams illustrating a module and corresponding spectra for which overlapping spectra input are passed as outputs according to a preferred embodiment of the present invention;

FIGS. 24A-24B show a generalized block diagram of a Spectrum Processor (SP) and corresponding wavelength spectra in accordance with a present embodiment of the invention.

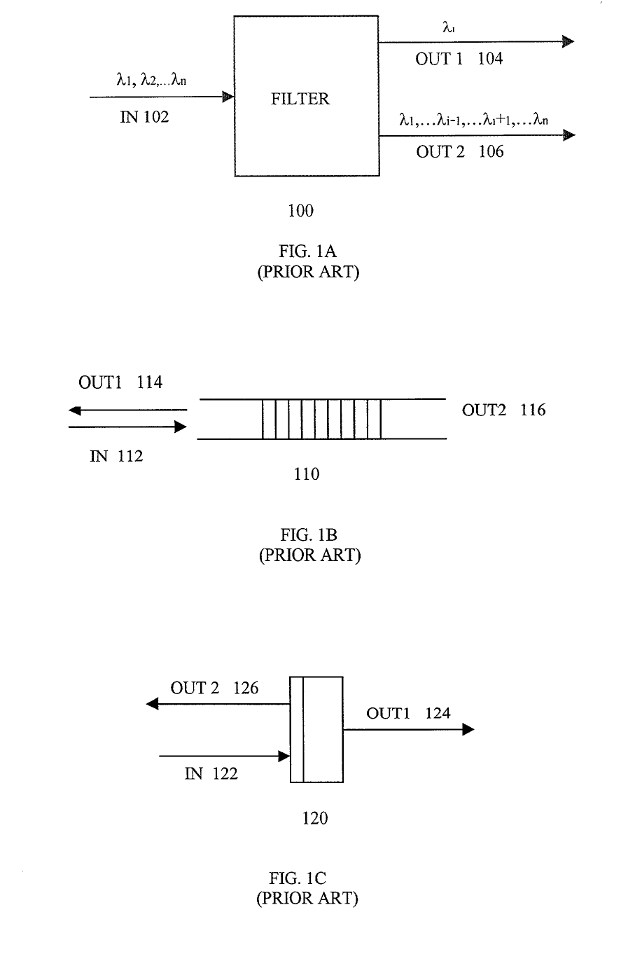

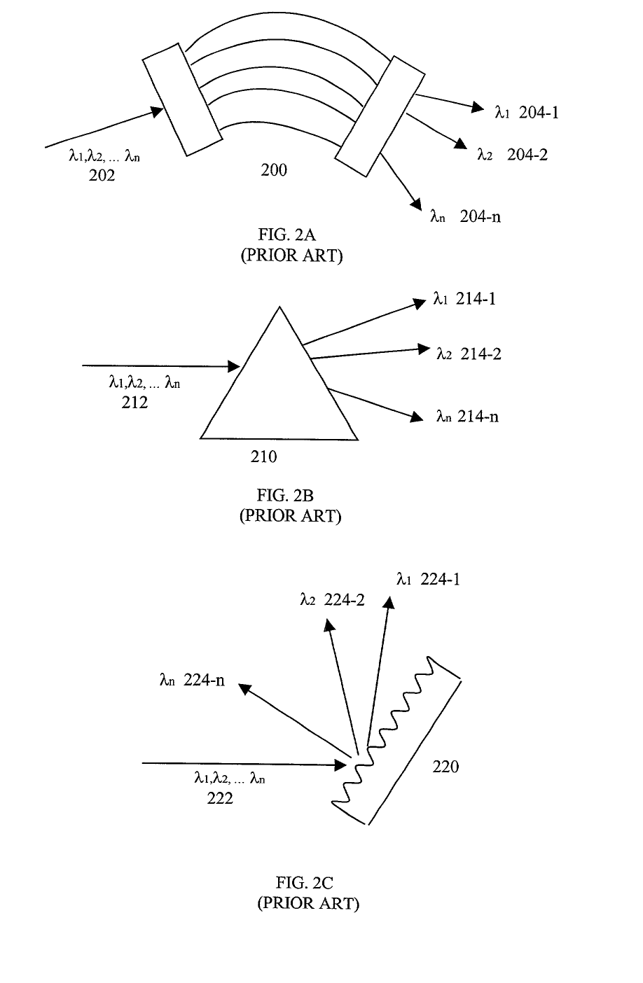

### DESCRIPTION OF THE PREFERRED EMBODIMENTS

The present invention comprises novel optical interleavers and related methods of interleaving optical signals. The following description is presented to enable any person skilled in the art to make and use the invention, and is provided in the context of particular applications and their requirements. Various modifications to the preferred embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles and features disclosed herein.

The illustrative drawing of FIG. 7A shows a generalized block diagram of an optical interleaver 700 in accordance with a present embodiment of the invention. The illustrative drawing of FIG. 7B shows an illustrative example of the optical output signal spectra of the two outputs of the optical interleaver 700. The optical interleave 700 alternatively may be referred to herein as an Optical Spectrum Synthesizer (OSS). Moreover, the terms “spectrum filter”, “1/n interleaver” and “spectrum splitter” may be used interchangeably to describe various embodiments of the invention.

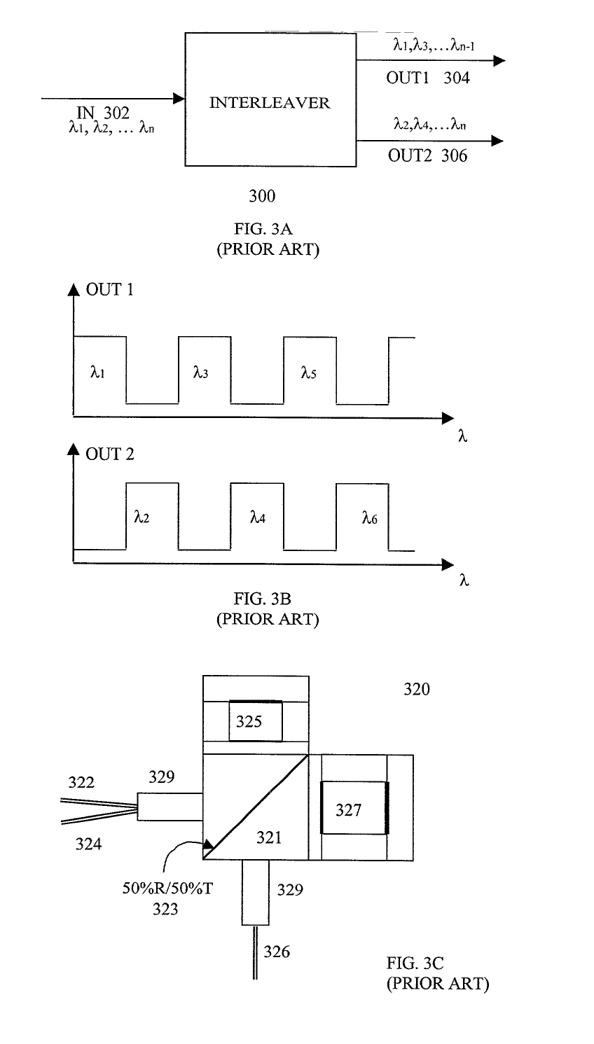

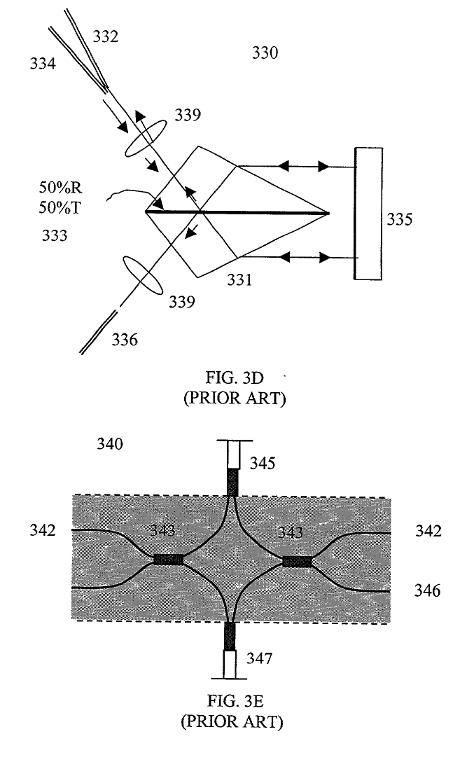

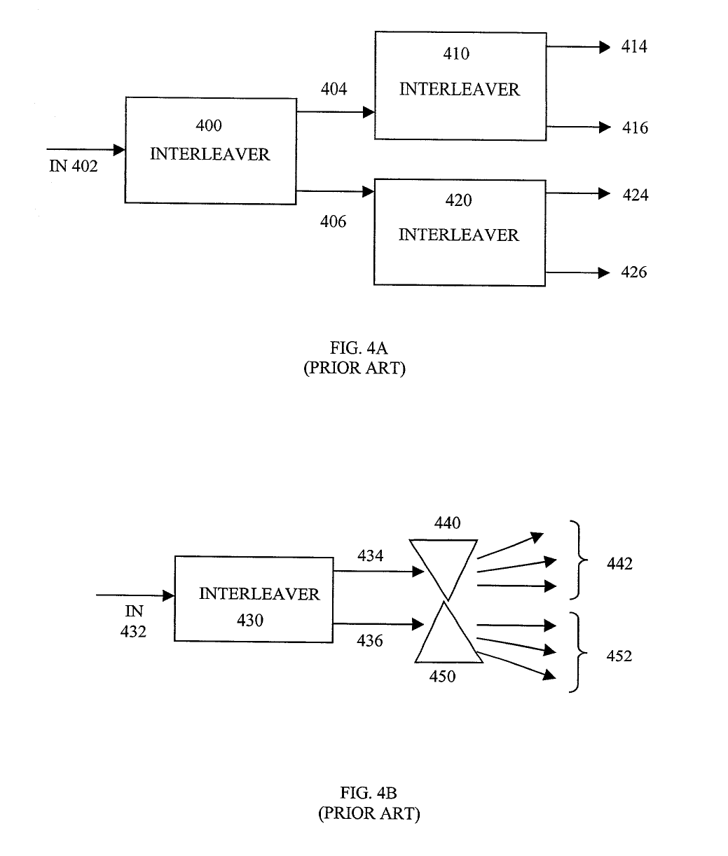

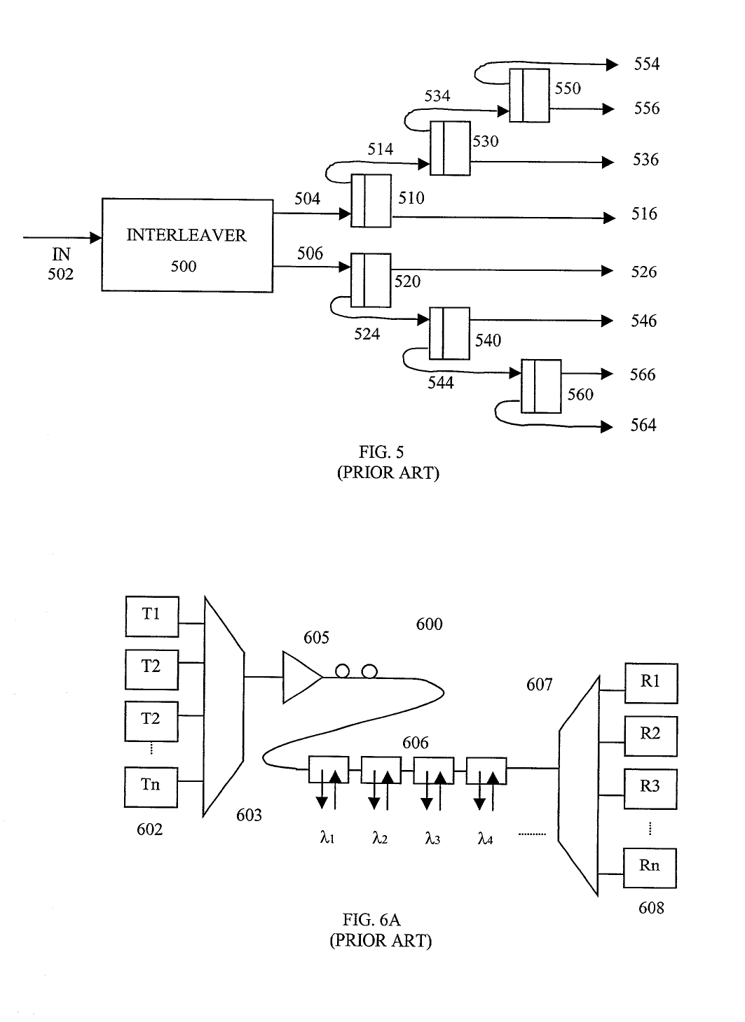

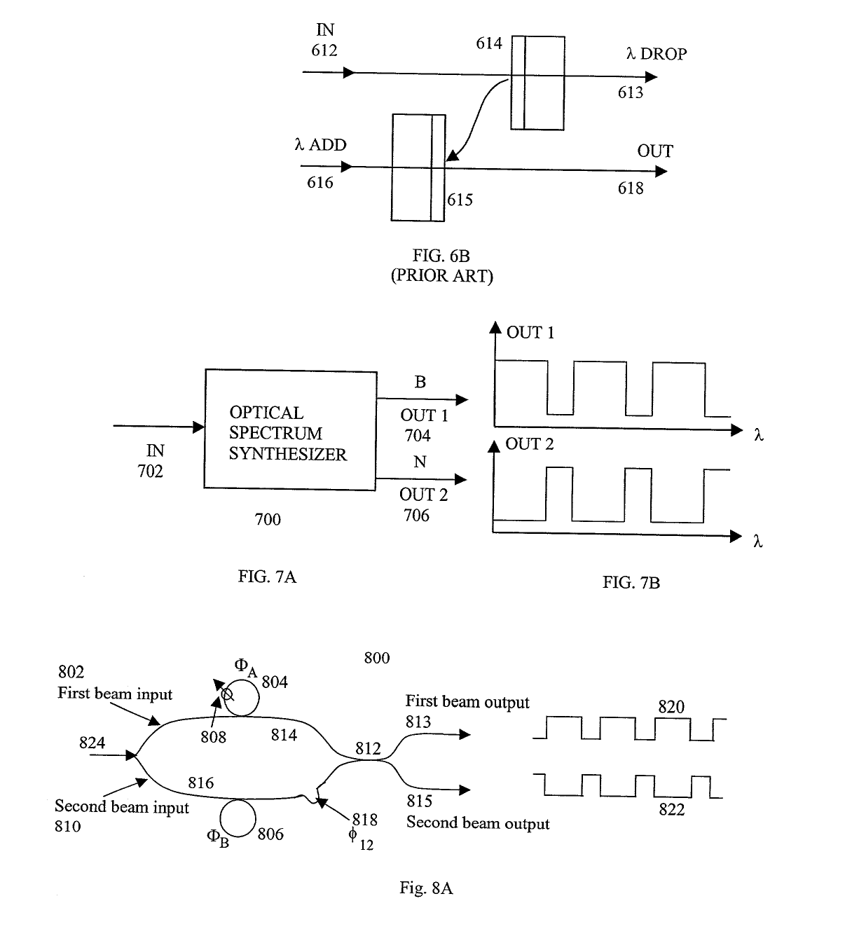

The OSS 700 illustrated in FIG. 7A has two outputs. One output (OUT 1) shown in FIG. 7B has a group of broader periodic pass bands with a predetermined bandwidth and period. The other output (OUT 2) shown in FIG. 7B has a group of narrower periodic pass bands, which compliments that of OUT 1. The outputs are complimentary in that the passbands of OUT 1 correspond to gaps between passbands in OUT 2, and vice-versa. The labels of OUT 1 and OUT 2 are not critical, and the outputs can also be labeled as N and B for narrow output and broad output. When the bandwidth of a N (narrow) output is set to be identical to that of a B (broad) output the passbands are equal and complimentary, and, the device operates as a conventional symmetric interleaver as displayed in FIGS. 3A-3D.

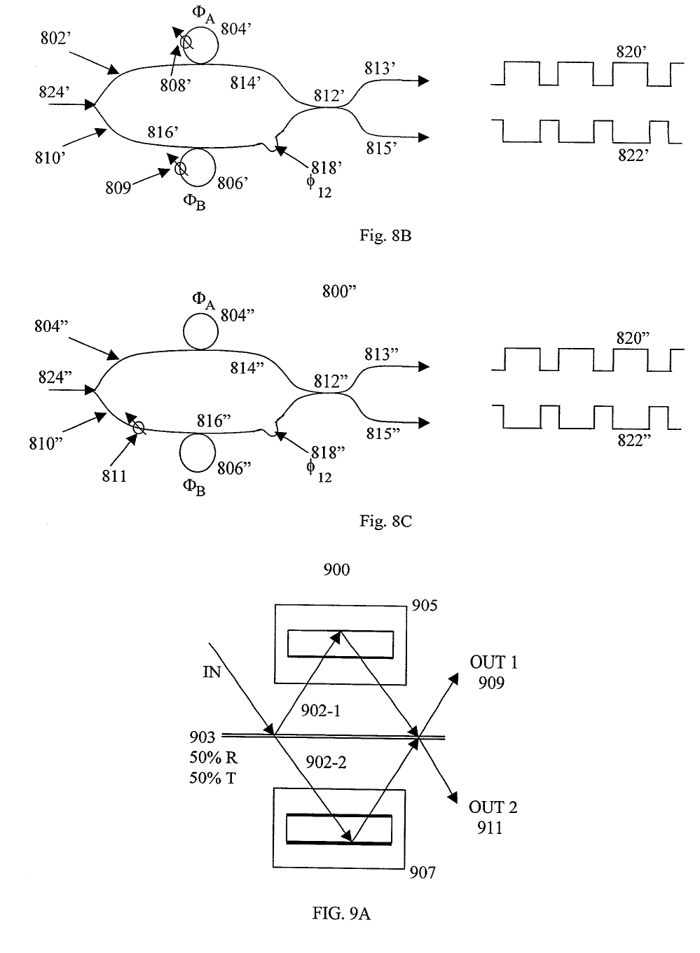

Referring to the illustrative drawings of FIGS. 8A-8C, there are shown generalized schematic diagrams of three alternative embodiments of an interleaver in accordance with certain aspects of the invention. Referring to FIG. 8A, there is shown a first optical interleaver 800, which operates as an interferometer which includes first, second and third phase shifters, 802, 804 and 806, respectively. The first phase shifter 802 is optically coupled to the second phase shifter 804 and to the third phase shifter 806. Light propagated along the first path by the first propagation element 814 is received by the second phase shifter 804. Light propagated along the second path by the second propagation element 816 is received by the third phase shifter 806. The second phase shifter 804 includes a phase shift tuner 808.

The interleaver 800 includes a light splitting element 810 and a light combining element 812. The light splitting elements 812 splits received light 824 into a first and second light beams having the same wavelength power spectra. The light combining element 812 interferometrically combines light of the first beam and light of the second beam.

The first phase shifter 802 includes a first light propagation element 814 that propagates light along a first path from the splitter 810 to the combiner 812. The first phase shifter 802 also includes a second light propagation element 816 that propagates light along a second path between the splitting element 810 and the combining element 812. A first phase shift imparted by the first phase shifter 802 results from a difference in path lengths of the first path and the second path. This difference is represented by path segment 818.

The second and third phase shifters 804, 806 impart periodic wavelength-dependent phase shifts. The second phase shifter 804 imparts a phase shift to first light received by it. The phase shift imparted by the second phase shifter 804 is dependent upon the wavelengths of the first light. Some wavelengths of the first light are in effect phase shifted, and other wavelengths of the first light are in effect not phase shifted. Similarly, the third phase shifter 806 impacts a phase shift to second light received by it. The phase shift imparted by the third phase shifter 806 is dependent upon wavelengths of the second light. Some wavelengths of the first light are in effect phase shifted, and other wavelengths of the second light are in effect not phase shifted.

The first, second and third phase shifters 802, 804 and 806 respectively, each contribute to a relative phase shift between first light propagated along the first path and second light propagated along the second path. The relative phase shifts imparted by the first, second and third phase shifters, therefore, determines respective variations in phase imparted to respective first light and to the second light. Through selection of the relative phase shift contributions of the first, second and third phase shifters, desired first and second output spectra 820 and 822 can be produced. The first and second output spectra 820 and 822 may be asymmetrical in that one may include a wider range of wavelengths than the other.

More specifically, the first phase shifter 802 imparts a relative phase shift of φ₁₂ between first light propagated along the first path and second light propagated along the second path 816. The relative phase shift imparted by the first phase shifter results from a difference in path lengths of the first path and the second path. The second phase shifter 804 imparts a wavelength-dependent phase shift of Φ_{A} to first light received by the second phase shifter 804. The third phase shifter 806 imparts a wavelength-dependent phase shift of Φ_{B} to second light received by the third phase shifter 806.

The overall phase difference between first light propagated along the first path and second light propagated along the second path can be expressed by the following relationship.

Δφ_{TOTAL}=Φ_{A}−Φ_{B}−φ₁₂

The relative phase shift between first light on the first path and second light on the second path depends upon the relative phases shifts imparted by the first, second and third phase shifters. It will be appreciated that this overall relative phase shift is determinative of the distribution of wavelengths between the first output spectrum 820 and the second output spectrum 822. As explained more fully below, through proper selection and control of the individual phase shifts imparted by the first, second and third phase shifters, desired first and second output light spectra, 820 and 822 respectively, can be produced.

In operation, the interferometer 800 receives a composite light signal 824 as an optical input splitting element. The splitting element 810 splits the input light into a first light beam and a second light beam. In a present embodiment, the first and second beams have the same wavelength power spectra. The splitting element 810 directs the first light to the first light propagation element 814. The splitting element 810 directs the second light to the second light propagation element 816. The first light propagation element 814 propagates the first light along the first path, and the second light propagation element 814 propagates the second light along the second path. The second phase shifter 804 receives at least a portion of the first light and imparts a first wavelength dependent variation in phase to the first light travelling on the first path. The third phase shifter 806 receives at least a portion of the second light and imparts a second wavelength dependent variation in phase to the second light travelling on the second path.

The combining element 812 receives the first light beam propagated on the first path by the first propagation element 816 and receives the second light beam propagated on the second propagation path by the second propagation element 818. The combining element 812 interferometrically couples the first light propagated on the first path with the second light propagated on the second path so as to achieve wavelength dependent variations in intensity of such first light beam and such second light beam. These variations in intensity are dependent upon the overall relative phase shift Δφ_{TOTAL}. The further variations in intensity depend upon the relative phase shift φ₁₂ imparted to the light of the first and second light beams by the difference in the first and second path lengths. The variations in intensity also depend upon the wavelength-dependent phase shift imparted to the light of the first beam received by the second phase shifter 804 and the wavelength-dependant different phase shift imparted to the light of the second beam received by the third phase shifter 806. The combining element 812 provides a first spectrum of wavelengths 820 on output path 813 and provides a complementary second spectrum of wavelengths 822 on output path 815.

In a present embodiment of the invention, the second phase shifter 804 includes a phase shifter tuner 808. Adjustment of the phase shifter tuner 808 changes the relative phase shift Φ_{A} associated with the second phase shifter 804. A change in the phase shift, Φ_{A}, in turn, changes the phase and shift imparted to first light received by the second phase shifter 804. Adjustment of the phases Φ_{A}, therefore, permits adjustment of the overall phase shift Δφ_{TOTAL} and adjustment of the complementary output spectra 820 and 822.

As explained below with reference to the various embodiments, it will be appreciated that in alternative embodiments, the first beam on the first path and the second beam on the second path may be derived from more than one optical input signal rather from a single optical signal 824. Moreover, for example, it will be appreciated that portions of the first and second paths may traverse free space. For instance, the respective first propagation element 816 and second propagation element 818 may comprise mirror surfaces that respectively direct the first and second light beams along the respective first and second paths.

The illustrative drawings of FIGS. 8B and 8C show alternative embodiments of the invention in employing other phase shifter tuners. Components in FIG. 8B that are the same as corresponding items in FIG. 8A are indicated by the identical reference numerals which are primed in FIG. 8B. Similarly, Components in FIG. 8C that are the same as corresponding items in FIG. 8A are indicated by the identical reference numerals which are double primed in FIG. 8C.

In FIG. 8B, there is a phase shifter tuner 809 associated with the third interferometer 806′. Thus, in the embodiment of FIG. 8B, both Φ_{A} and Φ_{B} can be adjusted. In the embodiment of FIG. 8C, there is a phase shifter tuner 811 associated with one of the propagation paths. Thus, in the embodiment of FIG. 8C, φ₁₂ can be adjusted. In yet another embodiment which is not shown, respective individual phase shifter tuners can be associated with each of the first, second and third phase shifters. In still another embodiment which is not shown, respective individual phase shifter tuners can be associated with each of the first and second phase shifters.

Thus, the optical interleaver embodiments of FIGS. 8A-8C advantageously permit variation in the power spectra of light transmitted on the first and second beam outputs. More specifically, the apportionment of constituent wavelengths of the input light beam 824 to the first beam output path 813 and to the second beam output path 815 of FIG. 8A depends upon Δφ_{TOTAL}, which in turn, depends upon Φ_{A}, Φ_{B} and φ₁₂. In the embodiment 800 of FIG. 8A, Δφ_{TOTAL} can be varied by adjustment to the phase shifter tuner 808 that varies the phase shift Φ_{A} associated with the second phase shifter 804. In the embodiment 800 of FIG. 8B, Δφ_{TOTAL} can be varied by adjustment to the phase shifter tuners 808′ and 809 that vary the wavelength dependent phase shifts Φ_{A} and Φ_{B} associated with the second and third phase shifters 804′ and 806′. In the embodiment 800 of FIG. 8C, Δφ_{TOTAL} can be varied by adjustment to the phase shifter tuner 811 that varies the phase shift φ₁₂ associated with the first phase shifter 810″. Thus, the distribution of wavelengths between the first and second beam outputs advantageously can be readily adjusted in accordance with the embodiments of FIGS. 8A-8C.

Generally speaking, the respective wavelength dependent phase shifts Φ_{A} and Φ_{B} imparted by the second and third phase shifters 804 and 806 together determine the periodicity of the first beam output on output path 813 and of the second beam output on output path 815. The phase shift φ₁₂ imparted by the first phase shifter 802 determines at least in part the amount or magnitude of variation in the power spectra of the first and second beam outputs. The sharpness of the periodic power spectra curves depends at least in part on how much of the first beam input is coupled to the second phase shifter 804 and upon how much of the second beam input is coupled to the third phase shifter 806.

For example that in the illustrative drawings of FIG. 7B, the OUT 1 and OUT 2 wavelength power spectra have very sharp (e.g., square) edges. The complementary power spectra of OUT 1 and OUT 2 are determined by the relative phase shifts associated with second and third phase shifters 804, 806. Note that the OUT 1 and OUT 2 are asymmetric with respect to each other. The depth of the variation in magnitude of the OUT 1 and OUT 2 spectra depends upon the phase shift imparted by the first phase shifter.

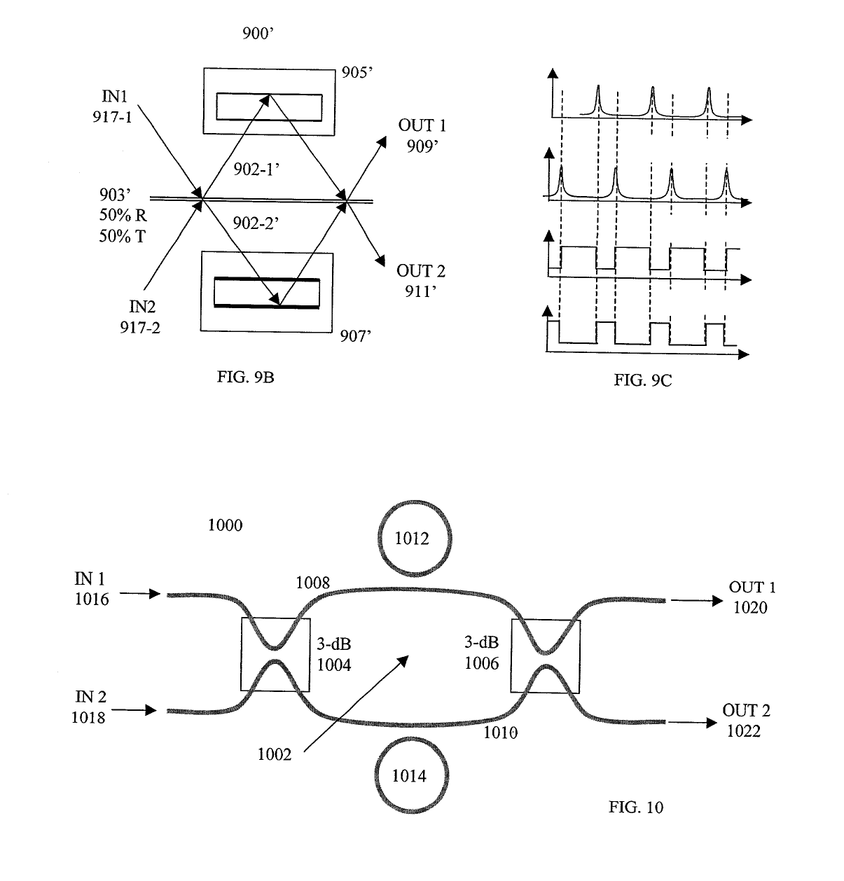

Referring to the illustrative drawings of FIG. 9A, there is shown a more detailed view of one embodiment of an interleaver 900, also referred to herein as an optical spectrum synthesizer (OSS), in accordance with certain aspects of the invention. The interleaver 900 comprises a 50% broadband non-polarizing beam splitter 903 and first and second GT mirrors 905 and 907. In a present embodiment, the splitter 903 is implemented with one or more 50% partial reflectors. The splitter 903 serves both to split an incident light beam 902 into first and second beams 902-1 and 902-2, each comprising the full spectrum of light incident upon the splitter 903. The splitter 903 also serves to combine phase-modified first and second light beams 902-1 and 902-2 so as to produce first and second outputs 909 and 911 with prescribed first and second output spectra such as the illustrative spectra of FIG. 7B, for example. Thus the splitter 903 operates as both a splitting element and a combining element. In one embodiment, input light 902 and output light beams 909 and 911 can be interfaced/coupled to optical fibers (not shown) through lenses (not shown). One type of lens that can be used for such coupling is a graded index lens known as GRIN lens.

The first beam follows a first optical path between the splitter and combiner. The second beam follows a second optical path between the splitter and combiner. The first and second path lengths are different resulting in a first phase shift φ₁₂ between the first light and the second light.

More specifically, incoming light 902, preferably a parallel beam with a small angular divergence, is directed to the beam splitter 903 at a prescribed incident angle with respect to the surface normal of the beam splitter 903. The beam splitter 903 splits the incident light into a first light 902-1 which is directed along the first path by the beam splitter 903 toward the first GT mirror 905 and second light 902-2 which is directed along the second path by the beam splitter 903 toward the second GT mirror 907. The first GT mirror 905 imparts a first wavelength-dependent phase variation Φ_{A} to the first light 902-1. The second GT mirror 907 imparts a second wavelength dependent phase variation Φ_{B} to the second light 902-2. The respective first and second GT mirrors 905 and 907 reflect respective incident phase-modified first and second light 902-1 and 902-2 back to the splitter 903 which recombines and re-branches the first and second light to produce respective first and second beam outputs 909 and 911. As explained more fully below, the first light 902-1 and the second light 902-2 travel different distances resulting in a phase shift of φ₁₂ between them.

The thicknesses of the respective optical cavities of the respective GT mirrors 905 and 907 are selected to obtain prescribed output spectra with prescribed channel spacing and/or wavelength separation. More particularly, the optical cavity of the first GT mirror 905 is selected to impart a wavelength dependent phase shift of Φ_{A} upon the first light 902-1 incident upon it. Similarly, the optical cavity of the second GT mirror 907 is selected to impart a wavelength dependent phase shift of Φ_{B} upon the second light 902-2 incident upon it. Basically, Φ_{A} and Φ_{B} influence the periodicity of the passband spectra of first output light 909 and second output light 911. Moreover, the overall distance traversed by the first light 902-1 in travelling between the point of incidence of the light 902 upon the splitter 903 and the point of incidence of the phase-modified first light 902-1 upon the splitter 903 is different from the overall distance traversed by the second light 902-2 in travelling between the point of incidence of the light 902 upon the splitter 903 and the point of the incidence of the phase-modified second light 902-2. This difference in distances, for example, can be achieved by spacing one GT mirrors 905 and 907 at different distances from the splitter 903. This difference contributes to the phase difference φ₁₂ between the first phase-modified light 902-1 and second phase-modified light 902-2. Thus, the output spectra depend upon Δφ_{TOTAL}, which in turn, depends upon Φ_{A}, Φ_{B} and φ₁₂.

In one embodiment, the reflective surfaces of the GT mirrors have reflectivities of approximately 18%, and 99.5% respectively. However, aspects of the invention encompass an interleaver with a 100% reflective back surface The coating thickness influences the sharpness of the passband curves of the output spectra. For instance, referring to the example spectra of FIG. 7B, the lines representing the spectra are shown as vertical. Changing the coating changes the slope of the passband spectra.

In order to match the center frequencies of the pass bands of first and second output light 909 and 911 to that of a standard communication grid (e.g., ITU grid), the incident angles and/or environment temperature(s) of the OSS 900 can be adjusted. In addition, one or both of the optical cavities of the respective GT mirrors 905 and 907 may be constructed with piezoelectric materials such that the free-spectra-range of each of the optical cavities may be controlled. Another approach to adjusting the free-spectra-range (FSR) of the “air-spaced” GT mirrors is to set and control the gas mixture and the pressure of the “air-spaced” cavity as described in detail in co-pending application Ser. No. ______ filed on Feb. ______, 2001. The temperature environment may also be controlled in a way to enhance the performance of the OSS 900. One or more electrical heaters and coolers can be placed close (within a few decimeters) to the two optical cavities to ensure best performance. The temperature sensitivity of the GT mirrors 905 and 907 can be reduced by using material with low thermal expansion. Temperature is important because typically a one degree centigrade change in temperature can have an effect on the critical product of width and index of refraction comparable to the required precision to achieve the desired outputs.

It will be appreciated that in the interleaver 900 of FIG. 9A, the beam splitter 903 provides a beam splitter function at the incidence point of the input light 902 and provides a beam combiner function at the incidence point of the first and second phase-modified first and second light 902-1 and 902-2. Furthermore, the beam splitter 903 and the first GT mirror 905 direct the first light 902-1 along a first path, and the beam splitter 903 and the second GT mirror 907 direct the second light 902-2 along a second path. The first and second paths traverse free space. The respective first and second GT mirrors 905 and 907 reflect the first and second light along the respective first and second paths in the course of their respective branching away from the splitter 903 and their convergence upon the splitter 903 where they are recombined and split. Thus, the first and second GT mirrors 905 and 907 serve as respective first and second propagation elements that imparts a relative phase shift of φ₁₂ to the first and second light 902-1 and 902-2. The first and second GT mirrors 905 and 907 also serve as second and third phase shifters that respectively impart phase shifts of Φ_{A} and Φ_{B} to the first and second light 902-1 and 902-2. The splitter 903 also serves as a combining element that it couples first light 902-1 along the first path that includes reflection off the first GT mirror 905 and that couples second 902-1 along the second path that includes reflection off the second GT mirror 907. Furthermore, the splitter 903 can be regarded as a coupler that interferometrically couples the first and second phase-modulated light 902-1 and 902-2 to produce the first and second output light 909 and 911.

In operation, each of the first and second GT mirrors (resonator, reflector, cavity) 905 and 907 provides a periodic phase shift in accordance with the following equation.

Φ=−2 tan⁻¹ {tan φ[(1+r)/(1−r)]} where φ=2πL₀/λ and r²=R.

Where L₀ is the optical path length of the respective GT mirror cavity, and R is the reflection of the front surface of the GT mirror. The respective phase shifts imparted by the first and second GT mirrors 905 and 907 is determined at least in part by the respective values of L₀ for each mirror. The optical path length is the sum nᵢ×lᵢ for each segment through which light travels. The value nᵢ is the index of refraction of segment i. The value lᵢ is the geometric length of segment i. The value L₀ represents the optical thickness between the partial and whole reflectors. The sharpness of the filter, (i.e., the slopes of the transmission curve on two sides of a passband) is determined at least in part by the reflectivity of the partial reflector of the GT reflectors. Ordinarily the front surface has a reflectivity within a range of 5% to 60%. The front surface reflectivity is selected so as to produce a desired splitting ratio. The splitting ratio is the ratio of power spectra traversing each path. The desired splitting ratio depends upon the particular application or use of the service. By way of example, a 33% coating will result in an approximately 1 to 3 splitting ratio.

Significantly, the quality of the interleaver 900 (i.e., the closeness to a square waveform) depends at least in part on the relative phase, or the optical paths difference of the two optical paths of the first interleaver (comprising the splitter 903 and the two GT mirrors 905 and 907) of the interleaver 900.

φ₁₂=2π(L1−L2)λ

Where L₁ and L₂ are the respective optical path lengths of the respective first path incident on the first GT mirror 905 and the second path incident on the second GT mirror 907. Each of the two optical paths traverses a different distance in travelling between the two points (entrance and exit) on the 50% beam splitter 903.

The periodicity of the passbands of the first light output 909 and the second light output 911 is determined by Φ_{A} and Φ_{B}. More specifically, the periodicity is determined, at least in part by the difference between Φ_{A} and Φ_{B} and by the phase difference φ₁₂ imparted by the first interferometer due to the difference in the optical path lengths of the first and second optical paths. The two periodic pass band output intensities I1 and I2 are represented by the following relationships.

I₁=I₀ cos²(ΔΦ/2); and

I₂=I₀ sin²(ΔΦ/2)

Where ΔΦ=Φ_{GT1}−Φ_{GT2}−φ

Note that if one adjusts the relative phase φ₁₂ to close to π/2, and the difference in phase imparted by the of the two GT mirrors by π/2, one can select operation as a symmetric interleaver. With different settings, however, one can select operation as an asymmetric interleaver.

In one embodiment of the invention, the first and second GT mirrors 905 and 907 serve as first and second tunable phase shifters. Specifically, the phase shift imparted by each such GT mirror 905 and 907 can be varied. There are several well-known approaches to such phase shift adjustment or tuning. In particular, the free spectral range (FSR) (in Hz) of a GT mirror is related to the index of refraction “n” of the medium within a cavity bounded by front and back surfaces of such mirror and the distance “d” between the front and back surfaces in accordance with the equation FSR=c/2nd. Where c is the speed of light. Since the FSR depends upon the optical thickness (nd) of the mirror cavity, changing the thickness d of the cavity can change the optical thickness.

One known mechanism for changing the optical thickness is to provide a variable spacer between the front and back surfaces. The variable spacer serves as a phase shift tuner that can be adjusted to change the physical spacing between the front and the back surfaces of the cavity. U.S. Pat. No. 6,169,604 issued to Cao, which is expressly incorporated herein by this reference, discloses various alternative approaches to adjusting the phase shift. For instance, one known approach is to provide two transparent precision plates, one within the cavity and another outside of it. The plate within the cavity can be rotated to change the FSR within the cavity. The plate disposed outside the cavity can be rotated to change the phase of the light incident upon the mirror. Another known GT mirror phase shift tuner includes a λ/8 wave plate disposed outside the mirror cavity which may be rotated to adjust the phase of light entering the cavity and to provide a λ/4 wave plate disposed within the cavity which may be rotated to change the FSR of the cavity. Another known GT mirror phase shift tuner includes two precision wave plates, each partially coated with a transparent material different from a transparent plate substrate. One wave plate is outside the cavity and changes the phase o flight entering the mirror cavity. The other plate is located within the cavity and changes the optical thickness of the cavity. Each of the plates can be rotated so as to vary the imparted phase shift. For instance, the thickness of the partially coated portions can be predetermined to give 90 degrees and 180 degrees of relative phase shift, respectively, for particular wavelengths required in specific applications.

Another mechanism to change the optical thickness is to change the index of refraction of an optical medium sealed within the cavity bounded by the front and back surfaces of a GT mirror. That mechanism is disclosed in commonly assigned U.S. patent application Ser. No. ______, filed on Feb. ______, 2001, entitled, “Phase and Free Spectra Range Adjustable Optical Reflectors For Dense Wavelength Division Multiplexing Applications”, which is expressly incorporated herein by this reference. In one embodiment, a GT mirror phase shift tuner includes an optical medium which comprises one or more selected gases that determine the index of refraction within the cavity. For instance, the optical medium may include a fluid comprising gas taken from the group comprised of N₂, O₂, Ne, Ar, Kr, Xe and SF₆. The tuning may be controlled by using a valve permitting changing of the gas or gas mixtures to thereby alter the index of refraction within the cavity so as to adjust the FSR. Moreover, in another embodiment, a GT mirror may comprise multiple cavities, one of which contains a fluid optical medium and another of which includes a wave plate or includes a phase plate.

Referring now to the illustrative drawings of FIG. 9B, there is shown an embodiment of an interleaver 900′, also referred to herein as an OSS. The embodiment of FIG. 9B is substantially identical to the interleaver 900 of FIG. 9A. However, in FIG. 9A, there is a single input light beam 902, and in FIG. 9B there are two input light beams 917-1 and 917-2. Components in FIG. 9B that are identical to corresponding components of FIG. 9A are referenced by primed reference numerals identical to the reference numerals used to designate the corresponding components in FIG. 9A. The two incoming light beams 917-1 and 917-2, preferably parallel beams with small angular divergences, are directed to the beam splitter 913′ at predetermined incident angles with respect to the surface normal. The splitter 913′ splits the two beams into branched beams 902-1′ and 902-2′ that are phase shifted and combined and re-branched in the same manner as described above with reference to the interleaver 900 of FIG. 9A.

Due to the fact that in practice, generally it is possible to make whole reflectors close to 100%, (e.g., 99.8%) there generally will be light leaked out to the other side of each GT mirror 905 and 907. This periodic weak transmission can be used as feedback monitor to adjust the optical thickness of the GT mirror cavity and hence the location of the pass band. The optical thickness of the GT mirror cavities can be adjusted so that the leakage light emerges from a portion of the back of the GT mirror that corresponds to the desired channel spacing.

More specifically, in accordance with another inventive feature of one embodiment of the invention, light leakage through back reflective surfaces of the respective first and second GT mirrors 905 and 907 can be used to assess the periodicity of the first and second light output spectra 909 and 911. This assessment can be used as a basis for adjustment of the variable phase imparted by each respective mirror so as to achieve desired first and second output spectra. Referring to the illustrative drawings of FIG. 9C, there is shown illustrative leakage spectra 913 and 915 through the respective back surfaces of the first and second GT mirrors 905 and 907. Also, in FIG. 9C, there is shown the respective wavelength power spectra of the first and second output light 909 and 911. The first and second leakage spectra 913 and 915 produced by light leaking through the backs of the first and second mirrors 905 and 907 are indicative of the respective power spectra of the first and second output light outputs 909 and 911. As shown in FIG. 9C, the periodicity of the leakage power spectra 913 and 915 is indicative of the periodicity of the output power spectra 909 and 911.

For instance, referring to FIG. 9C, wavelengths with a lower power in the first leakage spectrum 913 correspond to wavelengths at or near a lower wavelength side of a trough in the first output spectrum 909. Wavelengths at or near a lower power wavelength side of in the second leakage spectrum 915 correspond to wavelengths at a higher wavelength side of a trough in the first wavelength spectrum 909. Conversely, for example, wavelengths with a lower power in the first leakage spectrum 913 correspond to wavelengths at or near a lower wavelength side of a peak in the second output spectrum 911. Wavelengths at or near a lower power wavelength side of in the second leakage spectrum 915 correspond to wavelengths at a higher wavelength side of a peak in the second wavelength spectrum 911. Thus, by sensing the leakage spectra 913 and 915, it is possible to assess what adjustments to the first and/or second GT mirrors 905 and 907 are required to achieve a desired periodicity.

Referring now to the illustrative drawings of FIG. 10, there is shown an embodiment of an interleaver 1000, also referred to as an OSS, in accordance with other aspects of the invention. The interleaver 1000 includes a Mach-Zhender interferometer 1002 comprising first and second broadband non-polarizing beam splitters/combiners 1004, 1006 and first and second waveguides 1008, 1010. The first and second waveguides 1008, 1010 of the Mach-Zhender interferometer 1002 are respectively coupled to first and second ring resonators 1012, 1014. In a present embodiment, each of the splitters/combiners 1004, 1006 comprises a 3-dB splitter/combiner. The circumferences of the ring resonators 1012, 1014 are selected to obtain desired output spectra with desired channel spacing and/or wavelength separation.

In operation, two (or one) incoming light beams (beam) 1016, 1018 are provided as input(s) to the Mach-Zhender interferometer 1002. The first splitter/coupler 1004 mixes (if there are multiple input light beams) and separates the light input into first light propagated along the first arm 1008 and second light propagated along the second arm 1010. At least a portion of the first light on the first arm 1008 is coupled to the first ring resonator 1012, and at least a portion of the second light on the second arm 1010 is coupled to the second ring resonator 1014. In one embodiment, for example, the coupling coefficient of Mach-Zhender 1002 to each ring resonators 1012, 1014 is approximately 0.42. The phase of first light propagated on the first arm 1008 is modified through the operation of the first ring oscillator 1012. The phase of the second light propagated on the second arm 1010 is modified through the operation of the second ring oscillator 1014. The modified first light on the first arm 1008 and the modified second light on the second arm 1010 are provided to the second splitter/combiner 1006 which operates to recombine and re-branch the first and second beams so as to produce a further modified first light output 1020 and a further modified second light output 1022. It will be appreciated that in practice that only one of these multiple outputs may be of interest. The relative optical path difference of the two arms 1008, 1010 of the Mach-Zhender interferometer is selected to yield desired output spectra with proper channel spacing and/or wavelength separation of the first and second output light 1020, 1022. The first and second output light can be coupled to individual fibers.

It will be appreciated that the Mach-Zhender interferometer 1002 serves as a first phase shifter. The first ring resonator 1012 serves as a second phase shifter. The second ring resonator 1014 serves as a third phase shifter. Moreover, it will be understood that the coupling between the ring resonators 1012, 1014 and the waveguide arms 1008, 1010 has an effect similar to the reflectivity of the GT mirror surfaces of the embodiments 900 and 900′ of FIGS. 9A and 9B. For instance, an average of the optical circumference 2πn_{S}r of a ring resonator is similar in effect to the round trip distance 2nd cos θ between the two reflective surfaces of the GT mirror, where n_{S} is the effective index of refraction of the wave-guide substrate of the Mach-Zhender arms, r is a ring resonator radius, and nd cos θ is the optical path length within a GT mirror. Furthermore, the coupling coefficient from a wave-guide optical circuit containing 3 dB couplers to ring resonators can be selected to provide a coupling effect similar to that provided by the front partial reflector of the GT mirror (e.g., 14%, 18%, etc). Thus, the phase shift imparted by the ring resonators of the embodiment of FIG. 10 can be similar to that imparted by the embodiments of FIGS. 9A-9B.

In a present interleaver embodiment 1000, the ring resonators 1012, 1014 provide a periodic wavelength-dependent phase shift that can be expressed in accordance with the following equation.

$$Φ = arctan \frac{( {r}^{2} - 1 ) sin φ}{2 r - ( 1 + {r}^{2} ) cos φ} \qquad ( 1 )$$

with

$$φ = \frac{2 π}{λ} {L}_{0} \qquad ( 2 )$$

and

r²=R (3)

where L₀ is the optical path length of the ring, λ is the wavelength of the light in air, and R is the coupling coefficient of the coupler between one respective arm 1008 or 1010 of the Mach-Zhender 1002 and a corresponding respective ring resonator 1012, 1014. The phase shift imparted by a respective ring resonator can be adjusted by changing L₀.

The sharpness of the filter effect of the interleaver 1000, i.e., the slopes of the transmission curve on two sides of a pass band can be determined by the reflectivity of the respective ring resonators 1012, 1014. The quality of the OSS 1000, as measured in terms of closeness of the first and second output beam spectra 1020, 1022 to a square waveform, depends on the relative phase, or the optical path difference of the two arms of the OSS. The path difference is expressed as φ₁₂.

φ₁₂=2π(L₁−L₂)/λ

Where L₁ and L₂ are the optical paths inclusive of the first arm 1008 and the second arm 1010.

The periodicity of the passbands of the first light output 909 and the second light output 911 is determined by Φ_{ring1} and Φ_{ring2}. More specifically, the periodicity is determined, at least in part by the difference between Φ_{ring1} and Φ_{ring2} and by the phase difference φ₁₂ imparted by the first interferometer 1002 due to the difference in the optical path lengths of the first and second arms 1008, 1010. The two periodic pass band output intensities I1 and I2 are represented by the following relationships.

I₁=I₀ cos²(ΔΦ/2); and

I₂=I₀ sin²(ΔΦ/2)

Where ΔΦ=Φ_{ring}−Φ_{ring}−φ₁₂, and where I₀ is the initial intensity. Note that if the relative phase φ₁₂ is adjusted to be close to π/2, then a symmetric interleaving effect can be achieved. By selecting a different value of φ₁₂, and other parameters are appropriately in accordance with the above equations, an asymmetric interleaving effect can be achieved.

An advantage of an embodiment of an interleaver 1000 such as that in FIG. 10 is that it can be readily manufactured.

In order to match the center frequencies of the passing bands of output light 1020, 1022 to that of a standard communication grid (e.g., ITU grid), the optical path lengths of the first and second ring resonators 1012, 1014 may be adjusted. There are several well known approaches to adjusting the effective optical path lengths of the first and second ring resonators. For example, this may be accomplished through adjusting the substrate temperature, adjusting the substrate mechanical stress, adjusting the electric field across certain part of the waveguide, adjusting local magnetic field in certain regions of the waveguide, applying an acoustic wave to certain part of the waveguide, and a combination of the above adjustments of fields/forces. In addition, one or more electrical heaters and coolers may be placed close (within a few decimeters) to the waveguide to ensure best performance and stability. Temperature can be an important factor in performance of the interleaver 1000 because, for example, a one degree centigrade change in temperature can have an influence the critical product of width and index. Note that the interleaver 1000 of FIG. 10 does not include actual components to change the phase imparted by the first, second or third phase shifters. However, external components to adjust phase shift of any of the three phase shifters of interleaver 1000 using the physics mechanisms mentioned above are well known to persons skilled in the art and do not themselves form any part of this aspect of the invention.

Referring to the illustrative drawings of FIG. 11, there is shown an embodiment of an interleaver 1100 in accordance with other aspects of the invention. The interleaver 1100 comprises a Mach-Zhender interferometer 1102 comprising first and second broadband non-polarizing beam splitters/combiners 1104, 1106 and first and second waveguides 1108, 1110. In a present embodiment, the first and second splitters/combiners comprise 3-dB couplers. The first and second waveguides 1108, 1110 of the Mach-Zhender interferometer 1102 are respectively coupled to first and second GT mirrors 1112, 1114. A first collimating lens 1116 is interposed between the first waveguide arm 1108 and the first GT mirror 1112. A second collimating lens 1118 is interposed between the second waveguide arm 1110 and the second GT mirror 1114.

The first and second collimating lenses 1116, 1118 are operatively coupled to collimate light from respective point sources. More specifically, the first arm 1108 is formed of two segments 1108-1, 1108-2. The first arm 1108 has a first waveguide segment 1108-1 which includes a cut or other tap that 1108-1′ that provides what effectively serves as a point source 1108-1′ of first light. The first collimating lens 1116 collimates first light emanating from this point source 1108-1′ and passes it to the mirror 1112. Conversely, the first arm 1108 has a second waveguide segment 1108-2 which includes a cut or other tap 1108-2′ that receives as input, first light reflected from the first mirror 1112. Similarly, the second arm 1110 has a first waveguide segment 1110-1 which includes a cut or other tap that 1110-1′ that provides what effectively serves as a point source 1110-1′ of second light. The second collimating lens 1118 collimates second light emanating from this point source 1110-1′ and passes it to the mirror 1114. Conversely, the second arm 1110 has a second waveguide segment 1110-2 which includes a cut or other tap 1110-2′ that receives as input, second light reflected from the second mirror 1114.

The operation of the interleaver 1100 of FIG. 11 is generally similar to that of the interleaver 1000 of FIG. 10 except that the second and third phase shifters are implemented with GT mirrors 1112, 1114 in the interleaver 1100 of FIG. 11, and they are implemented with ring resonators 1012, 1014 in the interleaver 1000 of FIG. 10. More specifically, two (or one) incoming light beams (beam) 1120, 1122 are provided as input(s) to the Mach-Zhender interferometer 1102. The first splitter/coupler 1104 mixes (if there are multiple input light beams) and separates the light input into first light propagated along the first arm 1108 and second light propagated along the second arm 1110. At least a portion of the first light on the first arm 1108 is coupled to the first GT mirror 1112, and at least a portion of the second light on the second arm 1110 is coupled to the second GT mirror 1114. The phase of first light propagated on the first arm 1108 is modified through the operation of the GT mirror 1112. The phase of the second light propagated on the second arm 1110 is modified through the operation of the second GT mirror 1114. The modified first light on the first arm 1108 and the modified second light on the second arm 1110 are provided to the second splitter/combiner 1106 which operates to recombine and re-branch the first and second beams so as to produce a further modified first light output 1124 and a further modified second light output 1126. It will be appreciated that in practice that only one of these multiple outputs may be of interest. The relative optical path difference of the two arms 1108, 1110 of the Mach-Zhender interferometer 1102 is selected to yield desired output spectra with proper channel spacing and/or wavelength separation of the first and second output light 1124, 1126. The first and second output light can be coupled to individual fibers. In one preferred embodiment, the reflective surfaces of the GT mirrors have reflectivities of approximately 18%, and 99.5%, respectively.

In order to match the center frequencies of the passing bands of first light output 1124 and second light output 1126 to that of a standard communication grid (e.g., ITU grid), the optical path lengths through the two GT mirrors 1112, 1114 can be adjusted. As explained above in detail with reference to the embodiment of FIGS. 9A and 9B, this may be accomplished in several ways. For example, the incident angles of light upon the surfaces of the mirrors 1112, 1114 and/or environment temperature(s) of the mirrors can be adjusted. Alternatively, the thickness of the air spacers of the GT mirrors can be adjusted. The mirrors may be provided with an optical cavity of the which includes piezoelectric materials that changes dimensions with changes in voltage. Another approach described above is to adjust the free-spectra-range of the mirrors 1112, 1114 is to set and control the gas mixture and the pressure of the mirrors' cavities. In addition, one or more electrical heaters and coolers may be placed close (within a few decimeters) to the waveguide 1102 to ensure best performance and stability. As mentioned above, temperature is important because typically a one degree centigrade change in temperature can have an effect on the critical product of width and index of refraction comparable to the required precision to achieve the desired outputs.

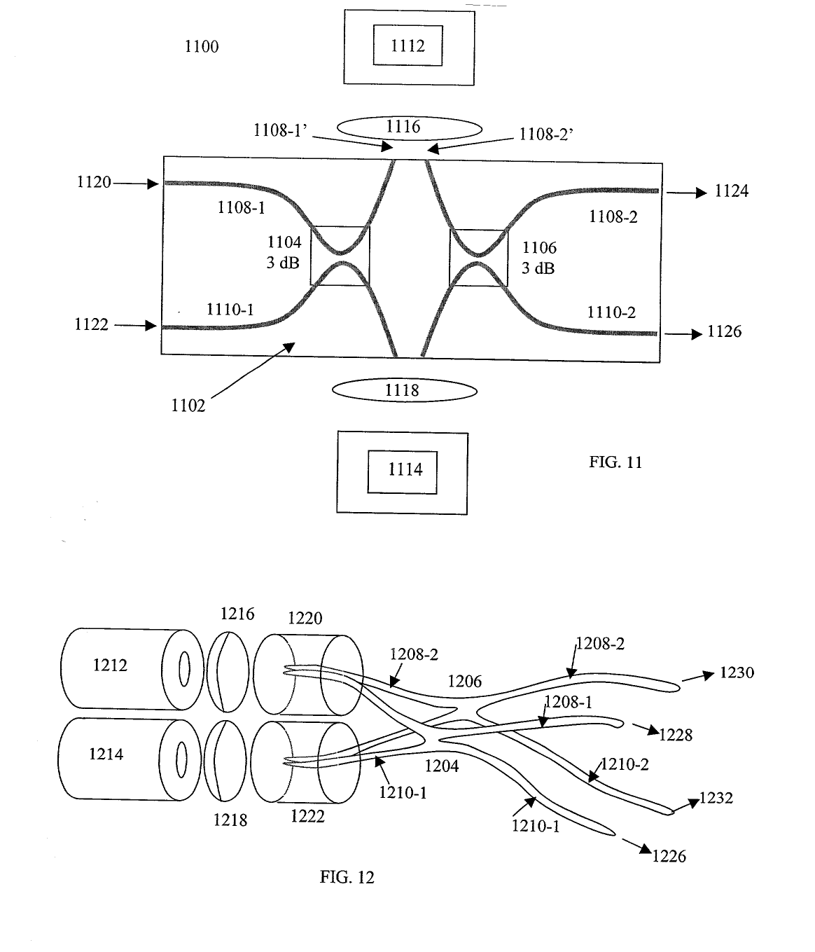

Referring to the illustrative drawings of FIG. 12, there is shown an embodiment of an interleaver 1200 in accordance with other aspects of the invention. It will be appreciated from the following explanation that the interleaver of FIG. 12 is similar to the interleaver of FIG. 11. A major difference between the interleavers of these two embodiments is that the interleaver of FIG. 11 is implemented using a waveguide 1102, but the interleaver 1200 of FIG. 12 is implemented using optical fiber 1202.

More specifically, referring to the illustrative drawings of FIG. 12, there is shown an embodiment of an interleaver 1200 in accordance with other aspects of the invention. The interleaver 1200 comprises a Mach-Zhender interferometer 1202 comprising first and second broadband non-polarizing beam splitters/combiners 1204, 1206 and first and second optical fiber paths 1208, 1210. In a present embodiment, the first and second splitters/combiners comprise 3-dB fiber couplers. The first and second fiber paths 1208, 1210 of the Mach-Zhender interferometer 1202 are respectively coupled to first and second GT mirrors 1212, 1214. A first collimating lens 1216 is interposed between the first fiber path 1208 and the first GT mirror 1212. A second collimating lens 1218 is interposed between the second fiber path 1210 and the second GT mirror 1214. First and second ferrules 1220, 1222 serve to hold the fibers 1208, 1210 in desired positions relative to the mirrors 1212, 1214.

The role of the first and second collimating lenses 1216, 1218 of the interleaver 1200 of FIG. 12 is similar to the role described above for the collimating lenses 1116, 1118 of the interleaver 1100 of FIG. 11. Also, the first and second fiber paths 1208, 1210 of the interleaver 1200 of FIG. 12 are segmented in a manner similar to the segmenting of the first and second waveguide arms 1108, 1110 of the interleaver 1100 of FIG. 11. In particular, the first fiber path includes a first input segment 1208-1 and an output segment 1208-2. The second fiber path 1210 includes an input segment 1210-1 and an output segment 1210-2. Therefore, in the interest of brevity, the roles of the lenses 1216, 1218 and the fiber segments shall not be described in detail for the embodiment of FIG. 12.

The operation of the interleaver 1200 of FIG. 12 is similar to that of the interleaver 1100 of FIG. 11. Therefore, the following explanation only addresses differences between these two embodiments. More specifically, two (or one) incoming light beam (beams) 1226, (1228) is provided as input(s) to the Mach-Zhender interferometer 1202. The first splitter/coupler 1204 mixes (if there are multiple input light beams) and separates the light input into first light propagated along the first arm 1208 and second light propagated along the second arm 1210. At least a portion of the first light on the first fiber path 1208 is coupled to the GT mirror 1212, and at least a portion of the second light on the second fiber path 1210 is coupled to the second GT mirror 1214. The phase of first light propagated on the first fiber path 1208 is modified through the operation of the GT mirror 1212. The phase of the second light propagated on the second fiber path 1210 is modified through the operation of the second GT mirror 1214. The modified first light on the first fiber path 1208 and the modified second light on the second fiber path 1210 are provided to the second splitter/combiner 1206 which operates to recombine and re-branch the first and second beams so as to produce a further modified first light output 1230 and a further modified second light output 1232. It will be appreciated that in practice that only one of these multiple outputs may be of interest. The relative optical path difference of the two arms 1208, 1210 of the Mach-Zhender interferometer 1202 is selected to yield desired output spectra with proper channel spacing and/or wavelength separation of the first and second output light 1230, 1232. The first and second output light can be coupled to individual fibers.

The center frequencies of the passing bands of the first light output 1230 and the second light output 1232 can be matched to that of a standard communication grid (e.g., ITU grid) using the techniques described for the other embodiments.

It will be appreciated that in the embodiments of FIGS. 10-12, the respective waveguides 1002, 1102 and fiber paths 1208, 1210 serve as light propagation elements that propagate first and second light along first and second paths. The ring oscillators 1012, 1014 also operate as light propagation elements in the embodiment of FIG. 10. The GT mirrors 1112, 1114 operate as light propagation elements in the embodiment of FIG. 11. The GT mirrors 1212, 1214 operate as light propagation elements in the embodiment of FIG. 12.

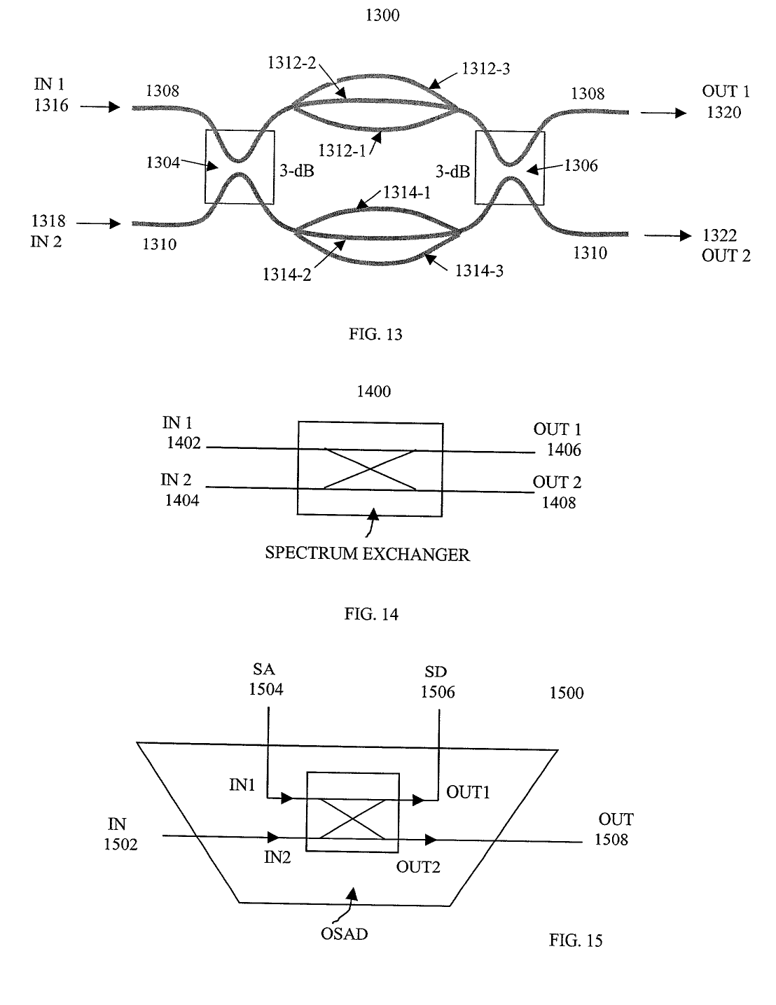

Referring to the illustrative drawings of FIG. 13, there is shown an embodiment of an interleaver 1300 in accordance with other aspects of the invention. The interleaver 1300 comprises a Mach-Zhender interferometer 1302 comprising first and second broadband non-polarizing beam splitters/combiners 1304, 1306 and first and second waveguides 1308, 1310. In a present embodiment, the first and second splitters/combiners comprise 3-dB couplers. The interleaver also includes second and third phase shifters 1312, 1314. Each of the second and third phase shifters 1312, 1314 includes a group of multiple waveguides. In a present embodiment, each group includes three waveguides. The second phase shifter 1312 includes a first group of waveguides 1312-1, 1312-2 and 1312-3. The third phase shifter 1314 includes a second group of waveguides 1314-1, 1314-2 and 1314-3. The respective optical paths of the waveguides in the first group are selected to impart a desired wavelength-dependent phase variation to first light received by the first group of wave guides. Similarly, the respective optical paths of the waveguides in the second group are selected to impart a desired wavelength-dependent phase variation to second light received by the second group of wave guides.

In operation, one (or more) incoming light beam (beam) 1316, (1318) are provided as input(s) to the Mach-Zhender interferometer 1302. The first splitter/coupler 1304 mixes (if there are multiple input light beams) and separates the light input into first light propagated along the first waveguide arm 1308 and second light propagated along the second waveguide arm 1310. The MZI itself serves as a first phase shifter which provides a relative phase shift between the first light and the second light. First light on the first path 1308 is coupled to the second phase shifter 1312, and second light on the second path 1310 is coupled to the third interferometer 1314. The phase of first light propagated on the first path 1308 is modified through the operation of the second phase shifter 1312. The phase and intensity of the second light propagated on the second path 1310 are modified through the operation of the third interferometer 1216. The modified first light on the first path 1308 and the modified second light on the second path 1310 are provided to the second splitter/combiner 1306 which operates to recombine and re-branch the first and second beams so as to produce a first light output 1320 and a second light output 1322. It will be appreciated that in practice that only one of these multiple outputs may be of interest. The relative overall optical path difference of the two arms 1308, 1310 of the Mach-Zhender interferometer 1302 is selected to yield desired output spectra with proper channel spacing and/or wavelength separation of the first and second output light 1230, 1232. The first and second output light can be coupled to individual fibers.

More specifically, the second and third phase shifters 1312, 1314 operate as follows. By carefully adjusting the portion of the light entering each waveguide of the first group, 1312-1, 1312-2 and 1312-3 and the portion of the light entering each waveguide of the first group, 1314-1, 1314-2 and 1314-3 and by also adjusting the difference of the optical paths between neighboring waveguides, these two waveguide groups can approximate the function of GT mirrors of the embodiments described above. One example of the arrangements is R₁/R₂/R₃=0.186/0.691/0.123, and the optical paths of waveguides satisfy: l₂−l₁=2πL₀/λ, and l₃−l₂=2πL₀/λ+π, where L₀ is the optical path length described above for a GT mirror. The two modified first and second light beams are then recombined and rebranched by the second coupler 1306 to produce the first output light 1320 and the second output light 1322.

The center frequencies of the passing bands of the first light output 1320 and the second light output 1322 can be matched to that of a standard communication grid (e.g., ITU grid) using the techniques described for the other embodiments.

Referring now to the illustrative drawing of FIG. 14, there is shown a generalized block diagram of a spectrum exchanger 1400 which may be implemented in accordance with the invention. In operation, an input optical signal IN 1 with a first wavelength spectrum is provided to input 1402, and an input optical signal IN 2 with a second wavelength spectrum is provided to input 1404. The spectrum exchanger 1400 provides an output optical signal OUT 1 that that has the first wavelength to output 1406. The spectrum exchanger 1400 provides an output optical signal that has the second wavelength spectrum to output 1408. The spectrum exchanger 1400 may be constructed using any of the embodiments described with reference to FIGS. 9A-13, for example. For instance, assuming that the embodiment 1100 of FIG. 11 is used to implement the spectrum exchanger 1400, the first, second and third phase shifts imparted by such interleaver 1100 would be selected such that the input optical signal 1120 would be provided as the output signal 1126, and such that the input optical signal 1122 would be provided as the output optical signal 1124.

Referring now to the illustrative drawing of FIG. 15, there is shown a generalized block diagram of an add/drop multiplexer 1500 which may be implemented in accordance with the invention. In operation, an input optical signal ISD that is to be dropped and that has a first wavelength spectrum is provided to a drop input 1502, and a an input optical signal SA that is to be added and that has a second wavelength spectrum is provided to an add input 1504. The add/drop multiplexer 1500 provides an output optical signal OSD that is dropped and that has the first wavelength to drop output 1506. The add/drop multiplexer 1500 provides an output optical signal that is added OSA and that has the second wavelength spectrum to add output 1508. The add/drop multiplexer 1500 may be constructed using any of the embodiments described with reference to FIGS. 9A-13, for example. For instance, assuming that the embodiment 1100 of FIG. 11 is used to implement the add/drop multiplexer 1500, the first, second and third phase shifts imparted by such interleaver 1100 would be selected such that an input optical signal 1120 would be provided as the dropped output optical signal 1126, and such that the input optical signal 1122 would be provided as the added output optical signal 1124.

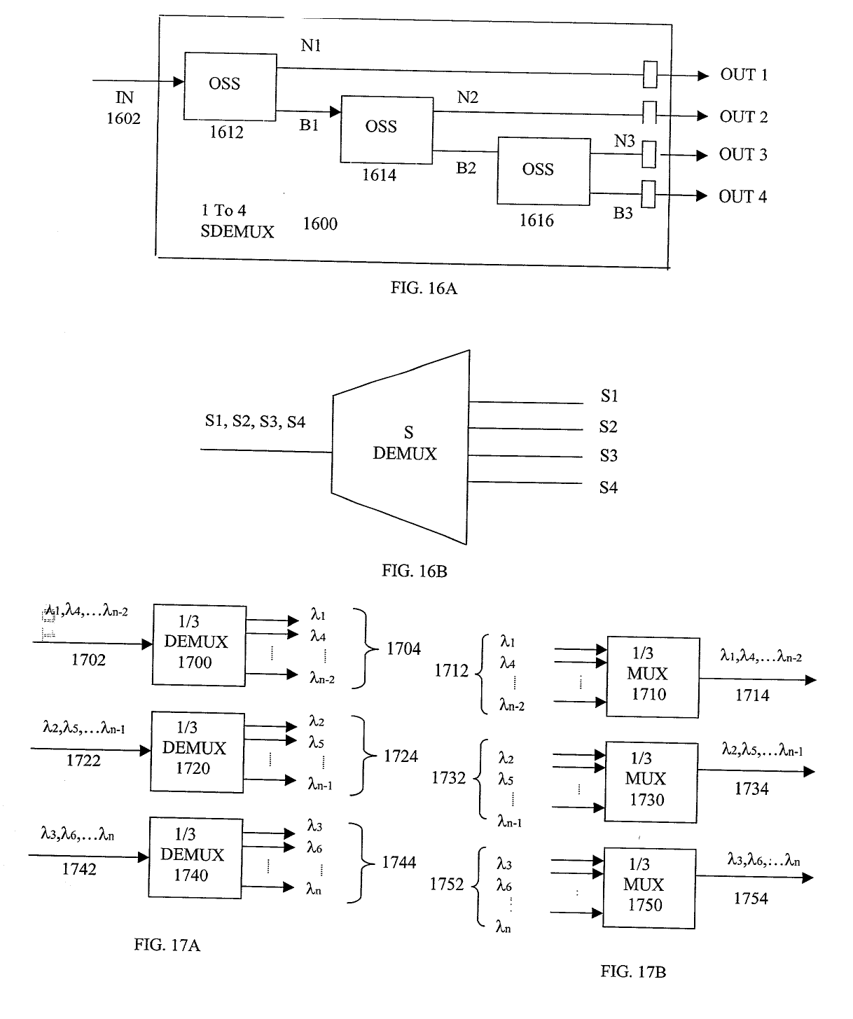

Referring to the illustrative drawing of FIG. 16A, there is shown a generalized block diagram of a one to four Spectrum De-Multiplexer (SDEMUX) 1600 constructed with multiple cascaded OSS devices 1612, 1614 and 1616 connected as shown. The OSS devices may be constructed using any of the embodiments described with reference to FIGS. 9A-13, for example. The respective first, second and third phase shifts of the OSS devices 1612, 1614, 1616 may be selected such that an input optical signal on input 1602 is divided evenly by the SDEMUX 1600 into four complementary spectra OUT 1, OUT 2, OUT 3 and OUT 4 with the same pass channel bandwidths on outputs 1604, 1606, 1608 and 1610. Alternatively, the respective first, second and third phase shifts of the OSS devices 1612, 1614, 1616 may be selected such that an input optical signal on input 1602 is divided unevenly by the SDEMUX 1600 into four complementary spectra OUT 1, OUT 2, OUT 3 and OUT 4 with the different pass channel bandwidths on outputs 1604, 1606, 1608 and 1610. In the embodiment illustrated in FIG. 16A, a narrower spectrum output (N₁) of a first OSS 1612 is provided to OUT 1, and a broader spectrum output (B₁) of the first OSS 1612 is provided as an input optical signal to a second OSS 1614. A narrower spectrum output (N₂) of the second OSS 1614 is provided to OUT 2, and a broader spectrum output (B₂) of the second OSS 1614 is provided as an input optical signal to a third OSS 1616. A narrower spectrum output (N₃) of the third OSS 1616 is provided to OUT 3, and a broader spectrum output (B₃) of the third OSS 1616 is provided as OUT 4. When used in the reverse direction, the SDEMUX 1600 of FIG. 16A operates as a spectrum multiplexer (SMUX) 1600 which receives different and complementary optical signals provided as input on nodes 1604, 1606, 1608 and 1610 and combines them to form a single composite output signal on node 1602. The drawings of FIG. 16B shows a proposed symbol for an SDEMUX.

FIGS. 17A-17B show a generalized block diagram of demultiplexer devices and multiplexer devices that can be constructed using OSS devices in accordance with the invention.

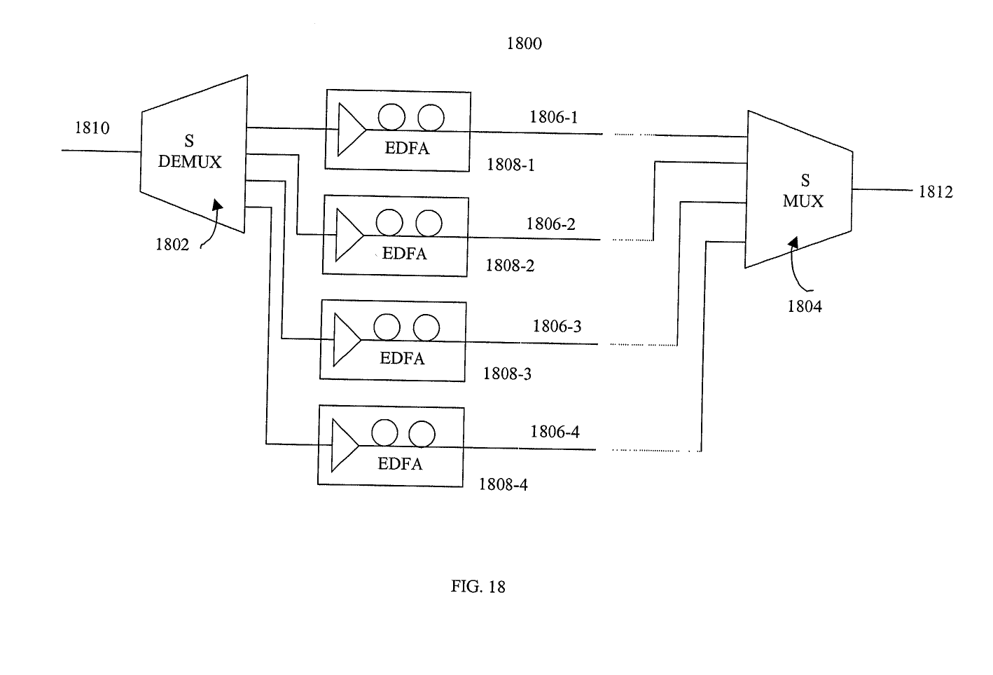

Referring to the illustrative drawings of FIG. 18, there is shown a generalized block diagram of a long haul system 1800 comprising an SDEMUX 1802, an SMUX 1804, multiple optical fibers 1806-1, 1806-2, 1806-3 and 1806-4 and multiple optical amplifiers 1808-1, 1808-2, 1808-3 and 1808-4 in accordance with the invention. In operation, a composite input signal on input 1810 is divided by SDEMUX 1802 into multiple complementary signals on the multiple optical fibers. The multiple complementary optical signals are re-combined into a single composite optical signal by SMUX 1804 which is provided on output 1812. The multiple respective optical amplifiers amplify the respective optical signals in the course of their transmission from the SDMUX 1802 to the SMUX 1804. The long haul system 1800 of advantageously can provide a wider channel spacing between wavelengths. Specifically, for the spacing between wavelengths of an optical signal on optical fiber 1806-1 can be made wider than that of wavelength spacings of typical conventional long haul systems. Similarly, the spacing between wavelengths on each of optical fibers 1806-2, 1806-3 and 1806-4 also can be made wider. One advantage of wider spacing of wavelengths on each optical fiber is a reduction in nonlinear effects. The reduced nonlinear effects permit higher optical power to be launched into each of the multiple optical fibers thereby significantly increasing the distances between amplification and/or recondition stations.

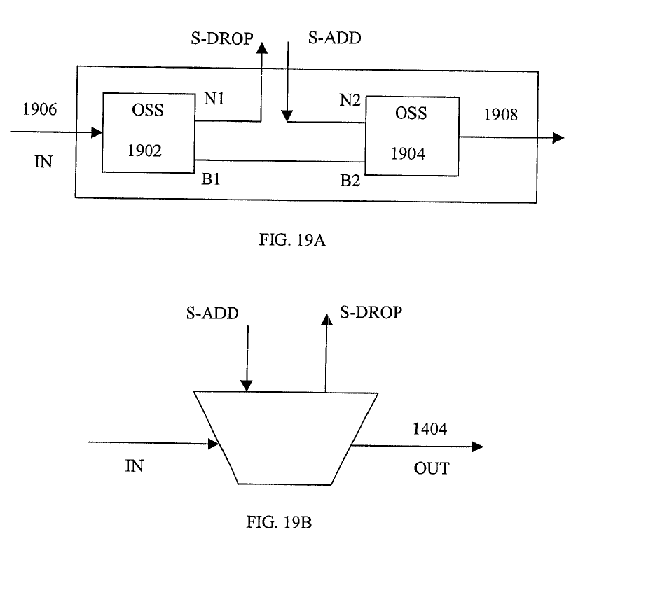

Referring now to the illustrative drawing of FIG. 19A, there is shown a generalized block diagram of an optical spectrum add/drop module (OSAD) 1900 which may be implemented in accordance with the invention. The OSAD 1900 includes first and second OSS devices 1902, 1904 connected as shown. Each OSS 1902, 1904 may be constructed using any of the embodiments described with reference to FIGS. 9A-13, for example. In the embodiment of FIG. 19A, first, second and third phase shifts imparted by the first OSS 1902 are selected such that an input optical signal IN provided to input 1906 of the first OSS 1902 is divided into a first narrower spectrum output optical signal N₁ and a first broader spectrum output optical signal B₁. The first narrower output optical signal N₁ is dropped (or provided to another device that is not shown). The first broader output optical signal B₁ is provided as one input to the second OSS 1904. A second narrower spectrum input optical signal N ₂ is provided as a second input to the second OSS 1904. The first, second and third phase shifts imparted by the second OSS 1904 are selected such that an output optical signal OUT is provided to output 1908 of the second OSS 1904 from the second narrower spectrum input optical signal N₂ and the first broader spectrum input optical signal B₁. It will be appreciated that by appropriate adjustment of the various phase shifts imparted by the first and second OSS devices 1902, 1904, the narrower and broader spectra can be reversed. The drawing of FIG. 19B shows a proposed symbol for an OSAD.

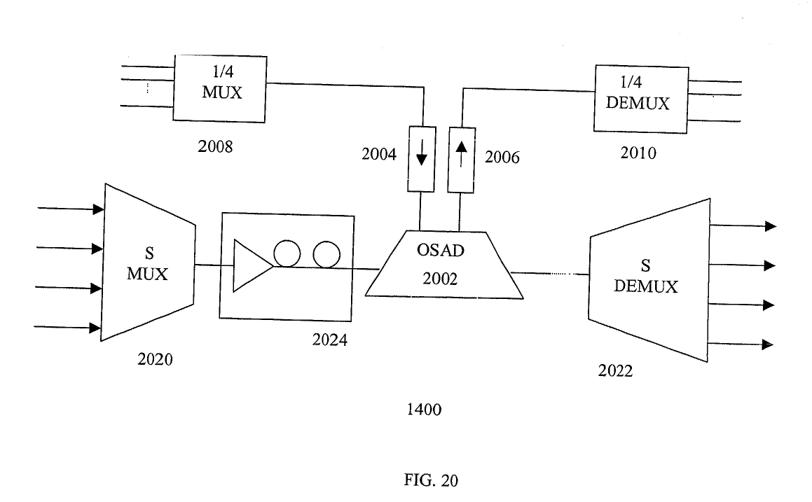

FIG. 20 shows one use of an OSAD in accordance with the invention. In particular, the illustrative drawings of FIG. 20 show a generalized block diagram of a long haul system 2000 comprising an OSAD 2002, an SMUX 2020, an SDEMUX 2022, and an optical amplifier 2024 connected as shown. The OSAD 2002 is used to add (a multiple wavelength) information an carrying signal 2004 in a prescribed spectrum which replaces a dropped (multiple wavelength) information carrying signal 2006 in the same spectrum. The added information carrying optical signal 2004 is provided by a multiplexing device 2008. The dropped information carrying signal 2006 is provided to a demultiplexing device 2010. The multiplexing and demultiplexing devices 2008, 2010 may be an OSS device in accordance with the invention or may be conventional devices.

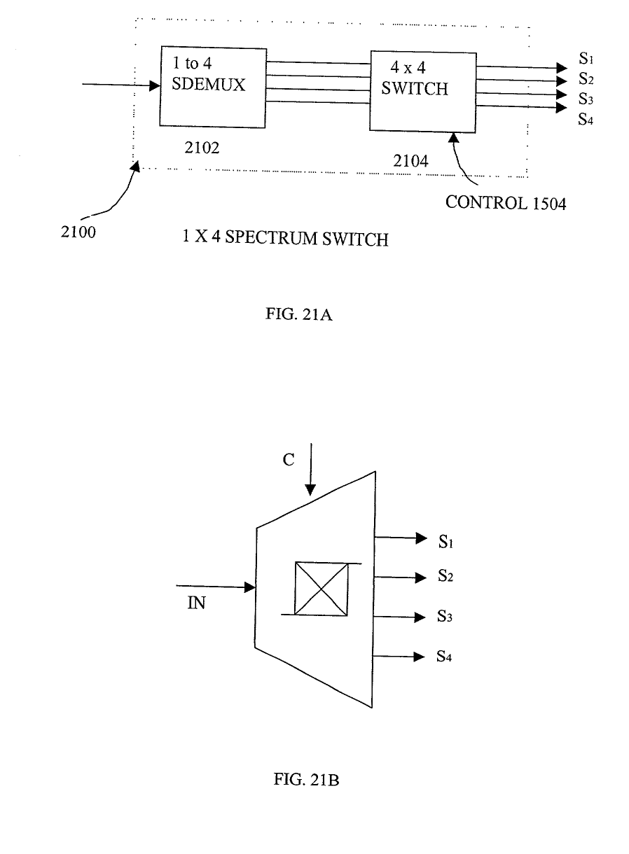

The illustrative drawing of FIG. 21A is a generalized block diagram of a 1×4 Spectrum Switch (SS) 2100 in accordance with a present embodiment of the invention. An SDEMUX 2102 is connected to a 4×4 optical switch 2104 as shown. FIG. 21B shows a proposed symbol for a spectrum switch.

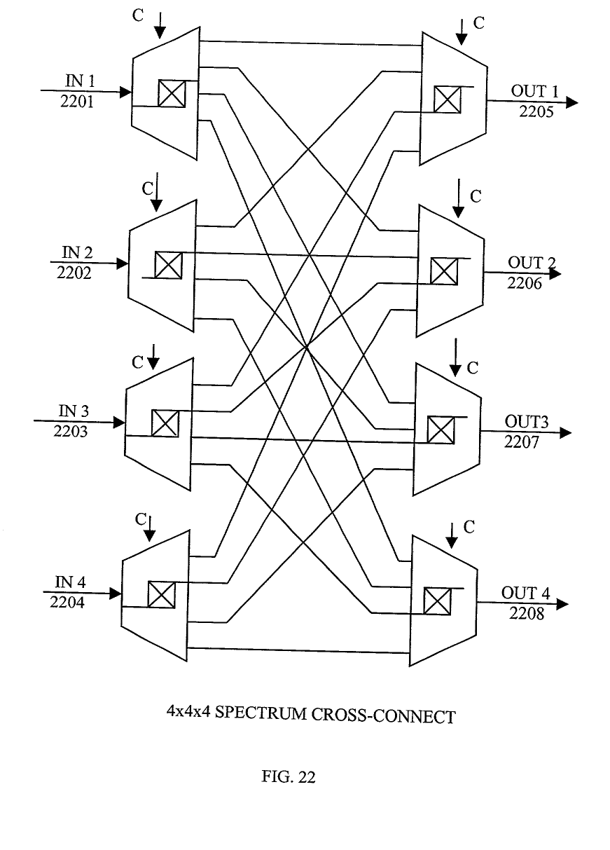

Referring to the illustrative drawing of FIG. 22, there is shown a generalized block diagram of a 4×4×4 Spectrum Cross-Connect (SCC) 2200 in accordance with a present embodiment of the invention. The construction of this SCC has a similar structure in comparison with a conventional optical cross-connect where different channels in a conventional cross connect are replaced by subgroups of channels in a SCC 2200. According to a preferred embodiment of the present invention, multiple (eight in the illustrated embodiment) 1×4 SS are connected to form an SCC. A general n×n×m SCC uses 2n 1×m SS connected in a way similar to a conventional n×n×m optical cross connect. Multiple input optical signals IN 1-4 provided to corresponding inputs (2201, 2202, 2203 and 2204) are cross connected and are provided as outputs OUT 1-4 on corresponding outputs (2205, 2206, 2207 and 2208).

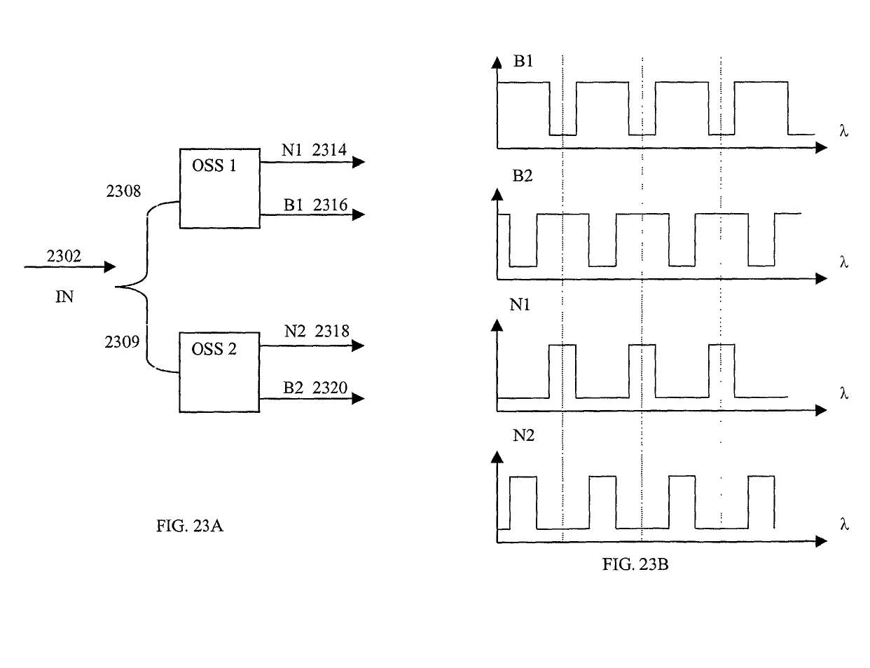

Referring to the illustrative drawings of FIGS. 23 A and 23B, there are shown diagrams illustrating a module 2300 and spectra for which overlapping spectra input 2302 are passed as the outputs 2314, 2316, 2324 and 2326, according to a preferred embodiment of the present invention. A wavelength insensitive branch coupler is used to branch the original composed data (2302) into two or several parts 2308, 2309. A first OSS 2310 and a second OSS 2312 split each branch into two sub-spectra each 2314, 2316, 2318 and 2320. These spectra are used in a collective way to process and pass data at a higher throughput rate than conventional methods by allowing certain degrees of crosstalk between adjacent channels. The crosstalk between adjacent channels is then removed through electronic and/or optical decoding of the original data.

More specifically, in more demanding applications, to use the same optical fiber to transmit more information, one will need to use frequency space previously not used due to the signal 23 overlap considerations. In this case, arrangement outlined in FIGS. 23A-23B will be beneficial. The signals are fist separated into two parts with a three dB coupler, each output is then passed through a OSS device with two outputs, narrow pass bands and broad pass bands. For each of the signal channels, there are two corresponding narrow and broad pass band signals. The narrow pass band signal provides low frequency components of the real signal with minimum cross talk from adjacent channels. Whereas the broad pass band signal provides high frequency components of the real signal with more cross talk. These two complementary signals can be recombined and the cross talk can be effectively eliminated.

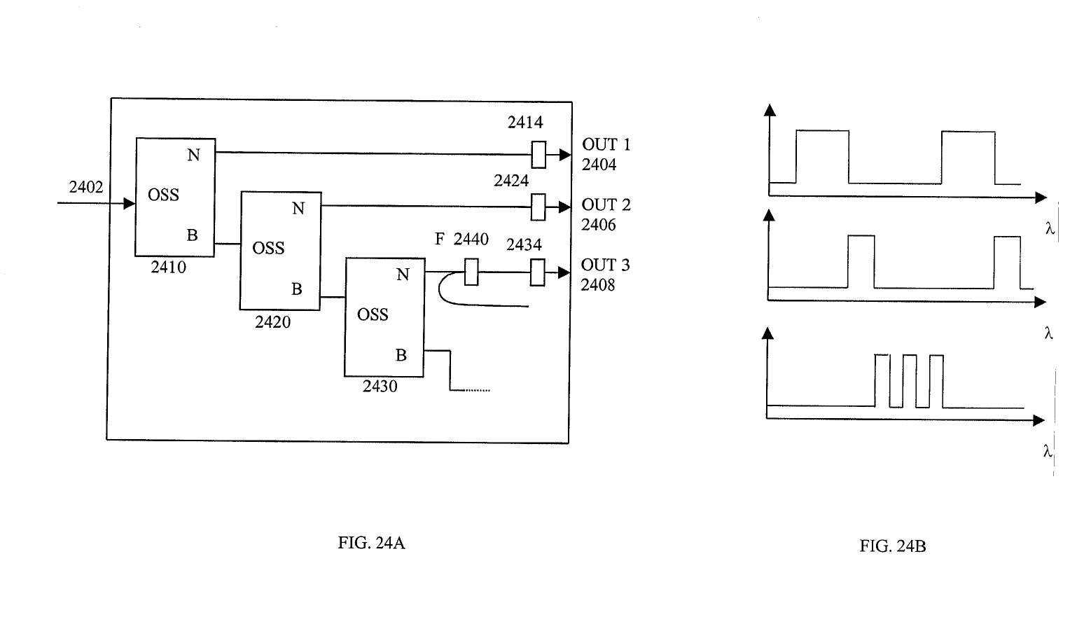

The illustrative drawings of FIGS. 24A and 24B show a generalizes block diagram of a Spectrum Processor (SP) 2400 in accordance with a present embodiment of the invention. The frequency space is divided to accommodate different OC protocols as well as to provide a group of channels all within a specific frequency window and with a different channel spacing and width. Such a SP module can be made with a combination of OSS 2410, 2420 and 2430 and filters 2414, 2424, 2434 and 2440 as illustrated in FIG. 24A generating the spectra of FIG. 24B.

In the example provided in FIGS. 24A-24B, three OSS devices are in a cascade. Each output is associated with a unique frequency spectrum. These outputs provide a flexible platform to arrange and redirect optical traffic. For example, in one case, different OC protocol channels may be passed through different outputs and redirected. In a different case, different number of channels having the same OC protocol may be branched to different outputs and redirected as groups.

Various modifications to the preferred embodiments can be made without departing from the spirit and scope of the invention. Thus, the foregoing description is not intended to limit the invention which is described in the appended claims in which:

1. An optical interleaver comprising:
an interferometer which includes a coupler, a first phase shifter and a combiner;
wherein the coupler splits incident light into a first light beam and a second light beam and couples the first light beam and the second light beam to the first phase shifter;
wherein the first phase shifter includes a first light propagation element that propagates the first light beam along a first path between the coupler and the combiner and that includes a second light propagation element that propagates the second light beam along a second path between the coupler and the combiner, the first and second paths having different path lengths that contribute to a phase shift between light of the first light beam propagated along the first path and light of the second light beam propagated along the second path;
wherein the combiner interferometrically couples the first light beam with and the second light beam;
a second phase shifter which receives first light beam light propagated along the first path between the coupler and the combiner and imparts a first wavelength dependent variation in phase to the received first light beam light;
a third phase shifter which receives second light beam light propagated along the second path between the coupler and the combiner and imparts a second wavelength dependent variation in phase to the received second light beam light; and
a phase shift tuner which adjusts a phase shift imparted to the first light beam by the second phase shifter.

2. The optical interleaver of claim 1,
wherein the second phase shifter includes a first resonator with a partially reflecting front mirror and a substantially fully reflecting back mirror spaced apart by a first distance;
wherein the third phase shifter includes a second resonator with a partially reflecting front mirror and a substantially fully reflecting back mirror spaced apart by a second distance different from the first distance;
wherein the second phase shifter is disposed relative to the splitter and combiner so as to serve as the first light propagation element by receiving light of the first beam from the splitter and reflecting received light of the first beam to the combiner; and
wherein the third phase shifter is disposed relative to the splitter and combiner so as to serve as the second light propagation element by receiving light of the second beam from the splitter and reflecting received light of the second beam to the combiner.

3. The optical interleaver of claim 1,
wherein the second phase shifter includes a first Gires Tournois resonator; and
wherein the third phase shifter includes a second Gires Tournois resonator.

4. The optical interleaver of claim 1 wherein,
spacing of the second phase shifter from at least one of the splitter and the combiner is different from spacing of the third phase shifter from at least one of the splitter and the combiner and such different spacing results in the different path lengths of the first path and the second path.

5. The optical interleaver of claim 1,
wherein the second phase shifter includes a first Gires Tournois resonator;; and
wherein the phase shift tuner includes a piezo-electric spacer between the front mirror and back mirror of the first Gires Tournois resonator.

6. The optical interleaver of claim 1,
wherein the second phase shifter includes a first Gires Tournois resonator;
wherein the third phase shifter includes a second Gires Tournois resonator; and
wherein the phase shift tuner includes at least one wave plate rotatably mounted between the front mirror and back mirror of the first Gires Tournois resonator.

7. The optical interleaver of claim 1,
wherein the phase shifter includes a first wave plate rotatably mounted between the front mirror and back mirror of the first Gires Tournois resonator to change the free spectral range of the first Gires Tournois resonator and a second wave plate rotatably mounted to change the phase of light of the first beam.

8. The optical interleaver of claim 1,
wherein the second phase shifter includes a first Gires Tournois resonator; d
wherein the third phase shifter includes a second Gires Tournois resonator;
wherein the phase shift tuner includes a first wave plate formed rotatably mounted between the front mirror and back mirror of the first Gires Tournois resonator to change the free spectral range of the first Gires Tournois resonator and a second wave plate rotatably mounted to change the phase of light of the first beam; and
wherein at least one of the first wave plate and the second wave plate is only partially coated with an additional material that is at least partially transparent.

9. The optical interleaver of claim 1,
wherein the second phase shifter includes a first Gires Tournois resonator;
wherein the third phase shifter includes a second Gires Tournois resonator; and
wherein the phase shift tuner includes a cavity defined by the front mirror and back mirrors of the first Gires Tournois resonator, the cavity filled with a fluid optical medium which determines an index of refraction with the cavity.

10. The optical interleaver of claim 1,
wherein the second phase shifter includes a first Gires Tournois resonator;
wherein the third phase shifter includes a second Gires Tournois resonator; and
wherein the phase shift tuner includes a cavity defined by the front mirror and back mirrors of the first Gires Tournois resonator, the cavity filled with a fluid optical medium which determines an index of refraction with the cavity; and
wherein the phase shift tuner further includes means for changing the fluid optical medium in the cavity.

11. The optical interleaver of claim 9 wherein the fluid optical medium comprises a gas taken from the group consisting of N2, O2, Ne, Ar, Kr, Xe, SF6 and mixtures thereof.

12. The optical interleaver of claim 1 further including:
a second phase shift tuner which can adjust the variation in phase imparted to the second light beam by the third phase shifter;
wherein the second phase shifter includes a first Gires Tournois resonator;
wherein the third phase shifter includes a second Gires Tournois resonator;
wherein the second phase shifter is disposed relative to the splitter and combiner so as to serve as the first light propagation element by receiving light of the first beam from the splitter and reflecting received light of the first beam to the combiner; and
wherein the third phase shifter is disposed relative to the splitter and combiner so as to serve as the second light propagation element by receiving light of the second beam from the splitter and reflecting received light of the second beam to the combiner.

13. The optical interleaver of claim 12 wherein
spacing of the second phase shifter from at least one of the splitter and the combiner is different from spacing of the third phase shifter from at least one of the splitter and the combiner and such different spacing results in the different path lengths of the first path and the second path.

14. The optical interleaver of claim 12,
wherein the first phase shifter includes a piezo-electric spacer between the front mirror and back mirror of the first Gires Tournois resonator; and
wherein the second phase shifter includes a piezo-electric spacer between the front mirror and back mirror of the second Gires Tournois resonator.

15. The optical interleaver of claim 12,
wherein the first phase shifter includes at least one wave plate rotatably mounted between the front mirror and back mirror of the first Gires Tournois resonator; and
wherein the second phase shifter includes at least one wave plate rotatably mounted between the front mirror and back mirror of the second Gires Tournois resonator.

16. The optical interleaver of claim 12,
wherein the first phase shifter includes a first wave plate rotatably mounted between the front mirror and back mirror of the first Gires Tournois resonator to change the free spectral range of the first Gires Tournois resonator and a second wave plate rotatably mounted to change the phase of light of the first beam; and
wherein the second phase shifter includes a first wave plate rotatably mounted between the front mirror and back mirror of the first Gires Tournois resonator to change the free spectral range of the second Gires Tournois resonator and a second wave plate rotatably mounted to change the phase of light of the second beam.

17. The optical interleaver of claim 12,
wherein the first phase shifter includes a first wave plate formed rotatably mounted between the front mirror and back mirror of the first Gires Tournois resonator to change the free spectral range of the first Gires Tournois resonator and a second wave plate rotatably mounted to change the phase of light of the first beam;
wherein at least one of the first wave plate rotatably mounted between the front mirror and back mirror of the first Gires Tournois resonator and the second wave plate rotatably mounted to change the phase of light of the first beam is only partially coated with an additional material that is at least partially transparent;
wherein the second phase shifter includes a first wave plate formed rotatably mounted between the front mirror and back mirror of the second Gires Tournois resonator to change the free spectral range of the second Gires Tournois resonator and a second wave plate rotatably mounted to change the phase of light of the second beam; and
wherein at least one of the first wave plate rotatably mounted between the front mirror and back mirror of the second Gires Tournois resonator and the second wave plate rotatably mounted to change the phase of light of the second beam is only partially coated with an additional material that is at least partially transparent.

18. The optical interleaver of claim 12,
wherein the first phase shifter includes a first cavity defined by the front mirror and back mirrors of the first Gires Tournois resonator, the first cavity filled with a fluid optical medium which determines an index of refraction within the first cavity; and
wherein the second phase shifter includes a second cavity defined by the front mirror and back mirrors of the second Gires Tournois resonator, the second cavity filled with a fluid optical medium which determines an index of refraction within the second cavity.

19. The optical interleaver of claim 12,
wherein the first phase shifter includes a first cavity defined by the front mirror and back mirrors of the first Gires Tournois resonator, the first cavity filled with a fluid optical medium which determines an index of refraction within the first cavity; and
wherein the first phase shifter further includes means for changing the fluid optical medium within the first cavity; and
wherein the second phase shift tuner includes a second cavity defined by the front mirror and back mirrors of the second Gires Tournois resonator, the second cavity filled with a fluid optical medium which determines an index of refraction within the second cavity; and
wherein the second phase shift tuner further includes means for changing the fluid optical medium within the second cavity.

20. The optical interleaver of claim 19,
wherein the fluid optical medium within the first cavity comprises a gas taken from the group consisting of N2, O2, Ne, Ar, Kr, Xe, SF6 and mixtures thereof; and
wherein the fluid optical medium within the second cavity comprises a gas taken from the group consisting of N2, O2, Ne, Ar, Kr, Xe, SF6 and mixtures thereof.

21. An optical interleaver comprising:
a first interferometer which includes a first coupler and a second coupler which are interconnected by a first waveguide which defines a first light path between the first coupler and the second coupler and which are interconnected by a second waveguide which defines a second light path between the first coupler and the second coupler;
wherein the first and second light paths have different path lengths that contribute to a relative phase shift between light of a first light beam propagated along the first light path and light of a second light beam propagated along the second light path;
a first ring resonator disposed adjacent to the first waveguide such that light of the first light beam is coupled between the first waveguide and the first ring resonator so as to impart a first wavelength dependent variation in phase and intensity to the first light beam which is dependent upon the optical circumference path length of the first ring resonator; and
a second ring resonator disposed adjacent to the second waveguide such that light of the second light beam is coupled between the second waveguide and the second ring resonator so as to impart a second wavelength dependent variation in phase and intensity to the second light beam which is dependent upon the optical path length of the second ring resonator.

22. The optical interleaver of claim 21 wherein the first coupler includes a 3-dB coupler.

23. The optical interleaver of claim 21 wherein the first coupler includes a 3-dB coupler and the second coupler includes a 3-dB coupler.

24. The optical interleaver of claim 21 wherein the first interferometer includes a Mach-Zhender interferometer.

25. An optical interleaver comprising:
a Mach-Zhender interferometer which includes a first coupler and a second coupler which are interconnected by a first light path between the first coupler and the second coupler and which are interconnected by a second light path between the first coupler and the second coupler; wherein the first light path includes a first waveguide optically coupled to a first Gires Tournois resonator and wherein the second light path includes a second waveguide optically coupled to a second Gires Tournois resonator and wherein the first and second light paths have different path lengths that contribute to a relative phase shift between light of a first light beam propagated along the first light path and light of a second light beam propagated along the second light path;
wherein the first Gires Tournois resonator includes a front mirror and a back mirror spaced apart by a first distance; and
wherein the second Gires Tournois resonator includes a front mirror and a back mirror spaced apart by a second distance different from the first distance.

26. The optical interleaver of claim 25 further including:
a first collimating lens disposed between the first waveguide and the first Gires Tournois resonator; and
a second collimating lens disposed between the second waveguide and the second Gires Tournois resonator.

27. The optical interleaver of claim 25 further including:
a first collimating lens disposed between the first waveguide and the first Gires Tournois resonator; and
a second collimating lens disposed between the second waveguide and the second Gires Tournois resonator
wherein the first waveguide includes two branches optically coupled through the first collimating lens and the first Gires Tournois resonator; and
wherein the second waveguide includes two branches optically coupled through the second collimating lens and the second Gires Tournois resonator.

28. The optical interleaver of claim 25 wherein the first coupler includes a 3-dB coupler.

29. The optical interleaver of claim 25 wherein the first coupler includes a 3-dB coupler and the second coupler includes a 3-dB coupler.

30. An optical interleaver comprising:
a Mach-Zhender interferometer which includes a first fiber coupler and a second fiber coupler which are interconnected by a first light path between the first coupler and the second coupler and which are interconnected by a second light path between the first coupler and the second coupler wherein the first light path includes a first fiber path optically coupled to a first Gires Tournois resonator and wherein the second light path includes a second fiber path optically coupled to a second Gires Tournois resonator and wherein the first and second light paths have different path lengths that contribute to a relative phase shift between light of a first light beam propagated along the first light path and light of a second light beam propagated along the second light path;
wherein the first Gires Tournois resonator includes a front mirror and a back mirror spaced apart by a first distance; and
wherein the second Gires Tournois resonator includes a front mirror and a back mirror spaced apart by a second distance different from the first distance.

31. The optical interleaver of claim 30 further including:
a first collimating lens disposed between the first fiber path and the first Gires Tournois resonator; and
a second collimating lens disposed between the second fiber path and the second Gires Tournois resonator.

32. The optical interleaver of claim 30 further including:
a first collimating lens disposed between the first fiber path and the first Gires Tournois resonator; and
a second collimating lens disposed between the second fiber path and the second Gires Tournois resonator
wherein the first fiber path includes two branches optically coupled through the first collimating lens and the first Gires Tournois resonator; and
wherein the second fiber path includes two branches optically coupled through the second collimating lens and the second Gires Tournois.

33. The optical interleaver of claim 30 wherein the first fiber coupler includes a 3-dB coupler.

34. The optical interleaver of claim 30 wherein the first fiber coupler includes a 3-dB coupler and the second fiber coupler includes a 3-dB coupler.

35. An optical interleaver comprising:
a Mach-Zhender interferometer which includes a first coupler and a second coupler and a first waveguide light path between the first and second couplers and a second waveguide light path between the first and second couplers; wherein the first and second light paths have different path lengths that contribute to a phase shift between first light propagated along the first path and second light propagated along the second path;
a second phase shifter which includes at least one second Mach-Zhender interferometer optically coupled to receive first light beam light propagated along the first path between the first coupler and the second coupler and which imparts a wavelength dependent variation in phase and intensity to the received first light beam light; and
a third phase shifter which includes at least one third Mach-Zhender interferometer optically coupled to receive second light beam light propagated along the second path between the first coupler and the second coupler and which imparts a wavelength dependent variation in phase and intensity to the received second light beam light.

36. The optical interleaver of claim 35 wherein the first coupler includes a 3-dB coupler.

37. The optical interleaver of claim 35 wherein the first coupler includes a 3-dB coupler and the second coupler includes a 3-dB coupler.

38. An optical interleaver comprising:
an interferometer which includes a coupler, a first phase shifter and a combiner;
wherein the coupler splits incident light into a first light beam and a second light beam and couples the first light beam and the second light beam to the first phase shifter;
wherein the first phase shifter includes a first light propagation element that propagates the first light beam along a first path between the coupler and the combiner and that includes a second light propagation element that propagates the second light beam along a second path between the coupler and the combiner, the first and second paths having different path lengths that contribute to a phase shift between light of the first light beam propagated along the first path and light of the second light beam propagated along the second path;
wherein the combiner interferometrically couples the first light beam with and the second light beam;
a second phase shifter which receives first light beam light propagated along the first path between the coupler and the combiner and imparts a first wavelength dependent variation in phase to the received first light beam light;
a third phase shifter which receives second light beam light propagated along the second path between the coupler and the combiner and imparts a second wavelength dependent variation in phase to the received second light beam light; and
a phase shift tuner which adjusts a phase shift imparted by a difference in path lengths between the first and second light paths.
